(19) United States
(12) Patent Application Publication
(10) Pub. No.: US 2025/0231099 A1
(43) Pub. Date: Jul. 17, 2025

(54) DETECTION DEVICE

(71) Applicant: Japan Display Inc., Tokyo (JP)

(72) Inventors: Kaoru ITO, Tokyo (JP); Akihiko FUJISAWA, Tokyo (JP); Daichi ABE, Tokyo (JP)

(21) Appl. No.: 19/013,186

(22) Filed: Jan. 8, 2025

(30) Foreign Application Priority Data
Jan. 11, 2024 (JP) 2024-002770

(51) Int. Cl. G01N 21/25; G01N 21/17; G01N 21/31

(52) U.S. Cl. CPC G01N 21/255; G01N 21/31; G01N 2021/1789; G01N 2201/061

(57) ABSTRACT

According to an aspect, a detection device includes: a sensor panel that has a detection area in which optical sensors are arranged; a light source unit comprising multiple types of light sources; a member on which an object to be detected is to be placed; and a detection circuit configured to obtain outputs of the optical sensors. The light sources configured to emit light in different colors are configured not to be turned on simultaneously but to be turned on in different periods. An exposure time when the optical sensor detects light differs between the light sources that emit light in different colors. The output of the optical sensor under conditions where the object to be detected is not placed falls within an output range corresponding to a predetermined target value, regardless of the color of the light emitted by one of the light sources that is turned on.

### CROSS-REFERENCE TO RELATED APPLICATION

This application claims the benefit of priority from Japanese Patent Application No. 2024-002770 filed on Jan. 11, 2024, the entire contents of which are incorporated herein by reference.

### BACKGROUND

### 1. Technical Field

What is disclosed herein relates to a detection device.

### 2. Description of the Related Art

Detection devices are known that enable detection of states of culture environments of biological tissues or microorganisms using an optical sensor (for example, Japanese Patent Application Laid-open Publication No. 2005-087005).

In the detection devices described above, color information can be added to detection results by providing light sources for a plurality of colors and performing the detection for each color of light. However, the light sources may have variations in luminance. Therefore, if the detection is performed without considering such variations in luminance, color tones caused by the variations in luminance are reflected in the detection results, and thereby reducing the detection accuracy of colors of the culture environments of the biological tissues or microorganisms to be detected.

For the foregoing reasons, there is a need for a detection device capable of increasing the detection accuracy of colors.

### SUMMARY

According to an aspect, a detection device includes: a sensor panel that has a detection area in which a plurality of optical sensors are two-dimensionally arranged; a light source unit comprising multiple types of light sources configured to emit light in colors different from one another; a member on which an object to be detected is to be placed so as to interpose the object to be detected between the detection area and the light source unit; and a detection circuit configured to obtain outputs of the optical sensors. Each of the optical sensors comprises a photodiode and is configured to obtain an output corresponding to a photocurrent generated corresponding to light detected by the photodiode. The light sources configured to emit the light in different colors are configured not to be turned on simultaneously but to be turned on in different periods. An exposure time when the optical sensor detects the light differs between the light sources that emit light in different colors. The output of the optical sensor under conditions where the object to be detected is not placed falls within an output range corresponding to a predetermined target value, regardless of the color of the light emitted by one of the light sources that is turned on.

### BRIEF DESCRIPTION OF THE DRAWINGS

FIG. 1 is a diagram illustrating a main configuration of a detection device;

FIG. 2 is a diagram illustrating a configuration example of a detection area and a wiring area;

FIG. 3 is a circuit diagram illustrating a circuit configuration of an optical sensor;

FIG. 4 is a schematic diagram illustrating a state of the detection device in operation;

FIG. 5 is a schematic view illustrating a configuration example of a light source;

FIG. 6 illustrates schematic views illustrating lighting patterns of the light source in a sensor scan;

FIG. 7 is a schematic graph illustrating a case where a correspondence relation between the type of the light source emitting light and light-receiving sensitivity of the optical sensor is relatively compared by the high/low level of the light-receiving sensitivity;

FIG. 8 illustrates diagrams schematically illustrating relations between exposure time and detected intensity of light indicated by a signal output by a photodiode;

FIG. 9 illustrates schematic diagrams illustrating a mechanism to determine a first exposure time, a second exposure time, and a third exposure time that are exposure times during each of which the detected intensity reaches a target value;

FIG. 10 is a timing diagram schematically illustrating an operation of the detection device reflecting the first exposure time, the second exposure time, and the third exposure time;

FIG. 11 is a flowchart illustrating a process related to determination of the exposure time of each light source;

FIG. 12 is a flowchart of an exposure time determination process;

FIG. 13 is a flowchart of the sensor scan;

FIG. 14 is a schematic view illustrating an example of the number of blocks in a detection area SA and the number of inputs to a multiplexer;

FIG. 15 is a diagram illustrating an exemplary individual detection process based on combinations of the blocks with the inputs to the multiplexer;

FIG. 16 is a flowchart illustrating a process related to the determination of the exposure time of each light source in a modification;

FIG. 17 is a flowchart illustrating a process of the exposure time determination process in the modification;

FIG. 18 is a flowchart of the sensor scan in the modification;

FIG. 19 is a schematic diagram schematically illustrating a configuration example of a detection system provided as a configuration including a detection device 1;

FIG. 20 is a schematic diagram illustrating a relation between one detection device 1 and an external configuration;

FIG. 21 is a schematic view illustrating a positional relation between a main configuration of the detection device 1 and an object to be detected SUB; and

FIG. 22 is a circuit diagram illustrating the optical sensor having a partially different configuration from that in FIG. 3.

### DETAILED DESCRIPTION

The following describes an embodiment of the present disclosure with reference to the drawings. What is disclosed herein is merely an example, and the present disclosure naturally encompasses appropriate modifications easily conceivable by those skilled in the art while maintaining the gist of the present invention. To further clarify the description, the drawings may schematically illustrate, for example, widths, thicknesses, and shapes of various parts as compared with actual aspects thereof. However, they are merely examples, and interpretation of the present disclosure is not limited thereto. The same element as that illustrated in a drawing that has already been discussed is denoted by the same reference numeral through the description and the drawings, and detailed description thereof may not be repeated where appropriate.

In this disclosure, when an element is described as being “on” another element, the element can be directly on the other element, or there can be one or more elements between the element and the other element.

### Embodiment

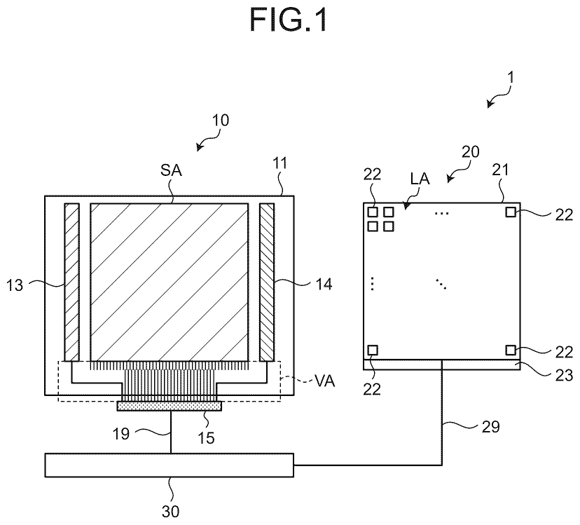

FIG. 1 is a diagram illustrating a main configuration of a detection device 1. The detection device 1 includes a sensor panel 10, a light source panel 20, and a control circuit 30. The sensor panel 10 and the light source panel 20 of the detection device 1 are coupled to the control circuit 30.

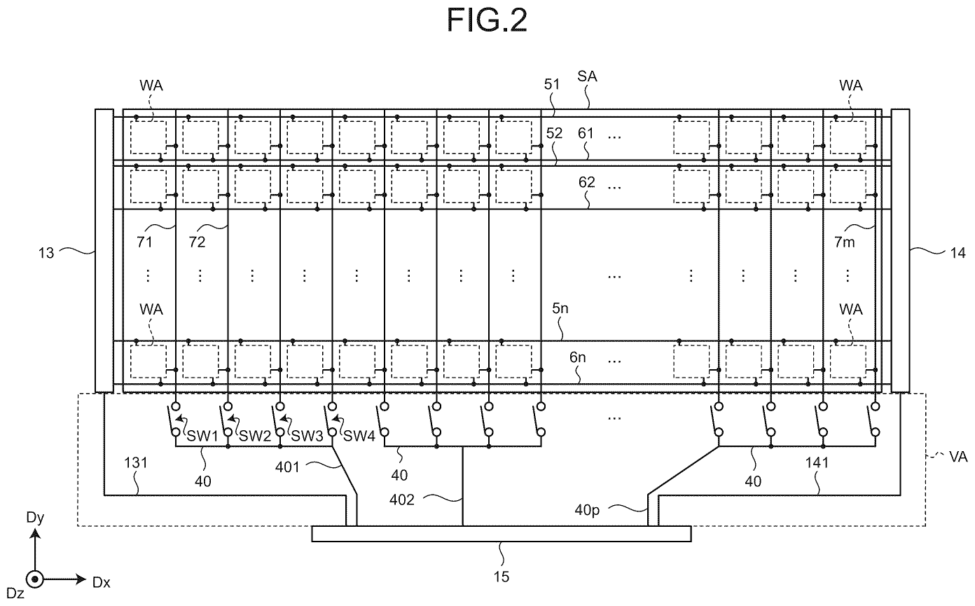

The sensor panel 10 is provided with a detection area SA (refer to FIG. 2) on a substrate 11. A reset circuit 13, a scan circuit 14, and a wiring area VA are mounted on the substrate 11. Components on the detection area SA, the reset circuit 13, and the scan circuit 14 are coupled to a detection circuit 15 via the wiring area VA.

The light source panel 20 has a light-emitting area LA that emits light to the detection area SA. The light source panel 20 is provided with a light source unit 22 on a substrate 21. The light source unit 22 includes a light-emitting element such as a light-emitting diode (LED), and is disposed in the light-emitting area LA. In the example illustrated in FIG. 1, a plurality of the light source units 22 are arranged in a matrix having a row-column configuration on the substrate 21.

The light source panel 20 is provided with a light source drive circuit 23. Under the control of the control circuit 30, the light source drive circuit 23 controls turning on and off each of the light source units 22 and the luminance thereof when being turned on. The light source units 22 may be provided so as to be individually controllable in light emission or may be provided so as to emit light all together.

The control circuit 30 performs various types of control related to the operation of the detection device 1. Specifically, the control circuit 30 is a circuit, such as a field-programmable gate array (FPGA) or an application-specific integrated circuit (ASIC) that can implement a plurality of functions. The control circuit 30 is coupled to the detection circuit 15 via a wiring part 19 and obtains an output from the detection circuit 15. The control circuit 30 is coupled to the light source drive circuit 23 via a wiring part 29 and performs processing related to the lighting of the light source units 22, such as individual lighting control of light sources (such as a first light source 22R, a second light source 22G, and a third light source 22B) included in the light source units 22 that emit light in different colors.

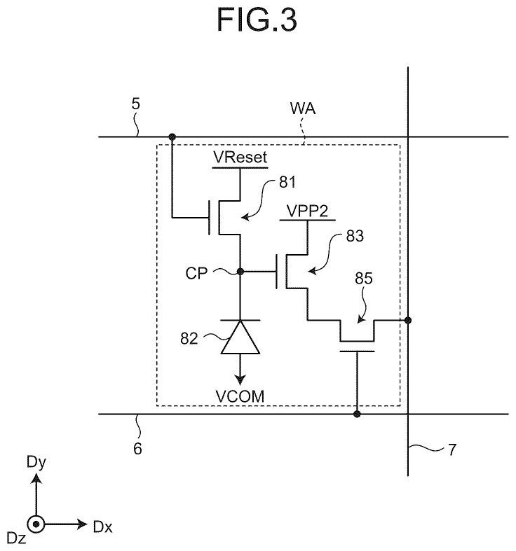

FIG. 2 is a diagram illustrating a configuration example of the detection area SA and the wiring area VA. A plurality of optical sensors WA (FIG. 3) are provided in the detection area SA. In the embodiment, as illustrated in FIG. 2, the optical sensors WA are arranged in a matrix having a row-column configuration along a first direction Dx and a second direction Dy. The first direction Dx is orthogonal to the second direction Dy. In the following description, the term “third direction Dz” refers to a direction orthogonal to the first direction Dx and the second direction Dy.

The reset circuit 13 is coupled to reset signal transmission lines 51, 52, . . . , 5n. Hereafter, the term “reset signal transmission line 5” refers to any one of the reset signal transmission lines 51, 52, . . . , 5n. The reset signal transmission line 5 is wiring along the first direction Dx. In the example illustrated in FIG. 2, n reset signal transmission lines 5 are arranged in the second direction Dy. n is a natural number equal to or larger than 2. The n reset signal transmission lines 5 are each coupled, at one end in the first direction Dx, to the reset circuit 13.

The scan circuit 14 is coupled to scan lines 61, 62, . . . , 6n. Hereafter, the term “scan line 6” refers to any one of the scan lines 61, 62, . . . , 6n. The scan line 6 is wiring along the first direction Dx. In the example illustrated in FIG. 2, n scan lines 6 are arranged in the second direction Dy. The n reset signal transmission lines 5 are each coupled, at the other end in the first direction Dx, to the scan circuit 14.

As illustrated in FIG. 2, the reset signal transmission lines 5 and the scan lines 6 are alternately arranged in the second direction Dy in the detection area SA. The reset circuit 13 and the scan circuit 14 illustrated in FIGS. 1 and 2 are arranged at locations facing each other with the detection area SA interposed therebetween, but the layout of the reset circuit 13 and the scan circuit 14 is not limited to this layout and can be changed as appropriate.

Signal lines 71, 72, . . . , 7m are also provided in the detection area SA. Hereafter, the term “signal line 7” refers to any one of the signal lines 71, 72, . . . , 7m. The signal line 7 is wiring along the second direction Dy.

In the example illustrated in FIG. 2, m signal lines 7 are arranged in the first direction Dx. m is a natural number equal to or larger than 2. The m signal lines 7 are each coupled, at one end in the second direction Dy, to one of a plurality of switches (for example, a switch SW1, a switch SW2, a switch SW3, or a switch SW4) included in a multiplexer 40.

The multiplexer 40 is provided in the wiring area VA. The multiplexer 40 includes a plurality of switches. In the example illustrated in FIG. 2, the switches SW1, SW2, SW3, and SW4 are illustrated as the switches. The switches included in one multiplexer 40 are turned on (conducting state) at different times from one another. During a period when one of the switches included in one multiplexer 40 is on (conducting state), the other switches are off (non-conducting state). The number of the multiplexers 40 corresponds to the number (m) of the signal lines 7. When the number of the switches is p, m/p is sufficient as the number of the multiplexers 40. When more than one multiplexer 40 are provided, each of the multiplexers 40 is coupled to the detection circuit 15 via an individual one of wiring lines 401, 402, . . . , 40p.

The coupling between the signal lines 7 and the detection circuit 15 via the multiplexer 40 is merely exemplary and is not limited to this example. The signal lines 7 may be individually directly coupled to the detection circuit 15 in the wiring area VA. In the wiring area VA, the reset circuit 13 is coupled to the detection circuit 15 via wiring 131. In the wiring area VA, the scan circuit 14 is coupled to the detection circuit 15 via wiring 141.

In the detection of light by a PD 82 (refer to FIG. 3) provided in the optical sensor WA, the detection circuit 15 controls the operation timing of the reset circuit 13 and the scan circuit 14. The detection circuit 15 receives an output from the optical sensor WA. The output of the optical sensor WA corresponds to an output of the PD 82 provided in the optical sensor WA. The detection circuit 15 converts signals received from the optical sensors WA into data that can be interpreted by the control circuit 30 and outputs the data to the control circuit 30. The detection circuit 15 of the embodiment is a micro-controller unit (MCU).

FIG. 3 is a circuit diagram illustrating a circuit configuration of the optical sensor WA. The first direction Dx and the second direction Dy in FIG. 3 merely correspond to the directions of the reset signal transmission lines 5, the scan lines 6, and the signal lines 7, and do not exactly indicate the relative positional relation of the circuit configuration in the optical sensor WA.

As illustrated in FIG. 3, a switching element 81, the PD 82, a transistor element 83, and a switching element 85 are provided in the optical sensor WA. The PD 82 is a photodiode (PD). The switching elements 81 and 85 and the transistor element are metal-oxide semiconductor field-effect transistors (MOSFETS).

The gate of the switching element 81 is coupled to the reset signal transmission line 5. One of the source and the drain of the switching element 81 is provided with a reset potential VReset. The other of the source and the drain of the switching element 81 is coupled to the cathode of the PD 82 and the gate of transistor element 83. Hereafter, the term “coupling part CP” refers to a point where the other of the source and the drain of the switching element 81 is coupled to the cathode of the PD 82 and the gate of transistor element 83. A reference potential VCOM is provided from the anode side of the PD 82. The potential difference between the reset potential VReset and the reference potential VCOM is set in advance, but the reset potential VReset and the reference potential VCOM may be variable. The reset potential VReset is higher than the reference potential VCOM.

The drain of the transistor element 83 serving as a source follower is provided with a source-of-output potential VPP2. The source of the transistor element 83 is coupled to one of the source and the drain of the switching element 85. The other of the source and the drain of the switching element 85 is coupled to the signal line 7. The gate of the switching element 85 is coupled to the scan line 6.

The reset potential VReset, the reference potential VCOM, and the source-of-output potential VPP2 are supplied by the detection circuit 15 to the optical sensor WA based on, for example, electric power supplied via a power supply circuit (not illustrated) coupled to the detection circuit 15, but are not limited to being supplied in this way, and may be supplied in a different way as appropriate.

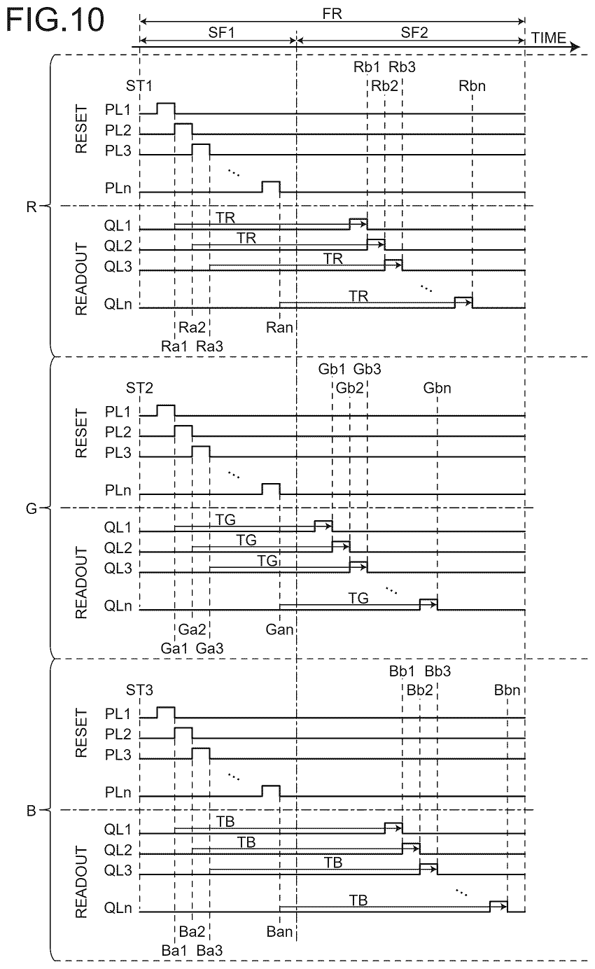

The source-of-output potential VPP2 is set in advance. The potential on the source side of the transistor element 83 is a potential lower than the output potential of the PD 82 by a voltage (Vth) between the gate and the source of the transistor element 83. In this case, the potential on the source side of the transistor element 83 corresponds to the reset potential VReset and the reference potential VCOM. The potential of the output of the PD 82 corresponds to photovoltaic power generated by the PD 82 and corresponding to the light detected by the PD 82 during an exposure time (for example, a first exposure time TR, a second exposure time TG, or a third exposure time TB illustrated in FIG. 10) to be described later.

Thus, the embodiment employs the configuration in which the optical sensor WA includes the PD 82; a photocurrent generated corresponding to the light detected by the PD 82 is stored as capacitance in the optical sensor WA (for example, the coupling part CP); and the detection circuit 15 acquires the output generated by a charge corresponding to the capacitance.

When the gate of the switching element 85 is turned on by a signal provided from the scan circuit 14 via the scan line 6, the source and the drain of the switching element 85 are brought into a conducting state therebetween. This operation transmits, to the signal line 7 via the switching element 85, a signal (potential) transmitted via the transistor element 83 to the switching element 85. Thus, the output from the optical sensor WA is generated. Hereafter, the term “readout signal” refers to the signal (potential) provided from the scan circuit 14 via the scan line 6. The scan circuit 14 is a circuit that outputs the readout signal.

The output of one PD 82 provided in one optical sensor WA corresponds to the intensity of the light detected by the PD 82 during the exposure time. The output of the PD 82 is reset in response to a signal (reset signal) provided by the reset circuit 13 via the reset signal transmission line 5. When the signal turns on the gate of the switching element 81, the source and the drain of the switching element 81 are brought into a conducting state therebetween. This operation resets the potential of the coupling part CP to the reset potential VReset.

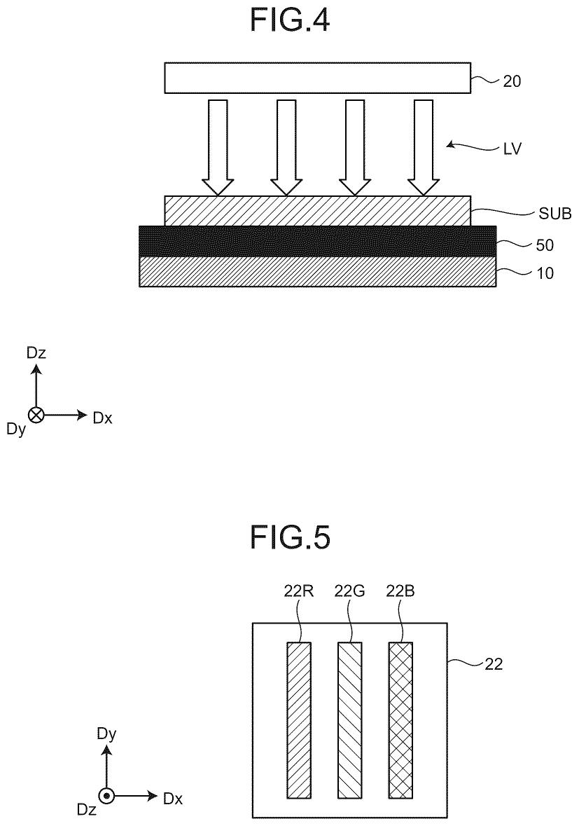

The following describes a state of the detection device 1 in operation with reference to FIG. 4. FIG. 4 is a schematic diagram illustrating the state of the detection device 1 in operation. In the detection device 1, the light source panel 20 and the sensor panel 10 are provided so as to face each other in the third direction Dz with an object to be detected SUB interposed therebetween. The object to be detected SUB is, for example, a Petri dish in which a culture medium (agar) is formed.

In the embodiment illustrated in FIG. 4, a light limiting member 50 is interposed between the object to be detected SUB and the sensor panel 10. The light limiting member 50 is a member that limits paths of part of light LV emitted from the light source panel 20 toward the sensor panel 10 that can reach the sensor panel 10. Specifically, the light limiting member 50 is, for example, a plate-like member dotted with a plurality of through-holes penetrating the member in the third direction Dz. Light that can pass through the light limiting member 50 is limited to light that passes through the through-holes. The through-holes correspond to the arrangement of the light source units 22 provided on the sensor panel 10. Each of the through-holes is provided so that each of the PDs 82 does not simultaneously detect light from two or more of the light source units 22. That is, in the embodiment, the light detected by one PD 82 is light from one light source unit 22. The through-hole is not provided individually for each of the PDs 82, but is shared by a plurality of the PDs 82. Therefore, the light from one light source unit 22 is shared by a plurality of the PDs 82. The light LV is light R1, light G1, or light B1, which is to be described later.

The object to be detected SUB is placed on the light limiting member 50 and in the detection area SA. Turning on the light source units 22 causes the light source panel 20 to emit light from above the object to be detected SUB toward the sensor panel 10. Of the light emitted from the light source units 22 toward the object to be detected SUB, light that has passed through the object to be detected SUB and the light limiting member 50 is detected by the PDs 82 (refer to FIGS. 3 and 4) in the detection area SA. Hereafter, the term “sensor scan” refers to a process in which the sensor panel 10 detects the light from the light source panel 20 when a positional relation between the light source panel 20, an object to be detected (such as the object to be detected SUB), the light limiting member 50, and the sensor panel 10 is established as illustrated in FIG. 4.

In the embodiment, when the object to be detected SUB is interposed between the sensor panel 10 and the light source panel 20, the light limiting member 50 is further interposed between the object to be detected SUB and the sensor panel 10, but the light limiting member 50 is not an essential component. Another optical member that functions in the same way as the light limiting member 50 may be employed, or the light limiting member 50 may be excluded.

The sensor scan is performed by detecting light from the light source units 22 using the PDs 82 under the setting conditions described with reference to FIG. 4. Hereafter, the term “sensor scan” refers to the process in which the sensor panel 10 detects the light emitted from the light source panel 20.

FIG. 5 is a schematic view illustrating a configuration example of the light source unit 22. The light source unit 22 is provided with multiple types of the light sources, each emitting light in a different color. Specifically, as illustrated in FIG. 5, the light source unit 22 of the embodiment includes the first light source 22R, the second light source 22G, and the third light source 22B. The first light source 22R, the second light source 22G, and the third light source 22B are light-emitting elements (such as LEDs) that emit light in different colors. In the embodiment, the first light source 22R emits red (R) light. The second light source 22G emits green (G) light. The third light source 22B emits blue (B) light.

The light source unit 22 illustrated in FIG. 5 has a configuration in which the longitudinal directions of the first light source 22R, the second light source 22G, and the third light source 22B are along the second direction Dy, and the first light source 22R, second light source 22G, and third light source 22B are arranged in this order from one side toward the other side in the first direction Dx. This configuration is, however, an exemplary form of the light source unit 22, which is not limited to this form. The shape of the first light source 22R, the second light source 22G, and the third light source 22B in the light source unit 22 as viewed from a planar viewpoint and the positional relation among the first light source 22R, the second light source 22G, and the third light source 22B can be changed as appropriate.

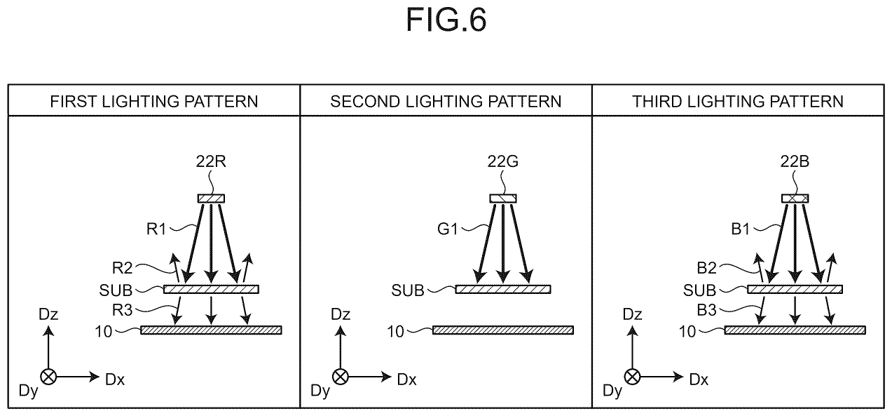

FIG. 6 illustrates schematic views illustrating lighting patterns of the light source unit 22 in the sensor scan. When the object to be detected SUB is located between the sensor panel 10 and the light source panel 20 as described with reference to FIG. 4, light that reaches the sensor panel 10 among light from the first light source 22R, light from the second light source 22G, and light from the third light source 22B depends on the color of the object to be detected SUB.

For example, assume a case where the object to be detected SUB is a culture medium (agar) tinged with purple by culturing of microorganisms. In this case, as illustrated in “First Lighting Pattern” in FIG. 6, part of the light R1 emitted from the first light source 22R toward the object to be detected SUB is reflected by the object to be detected SUB and scattered as light R2. Part of the light R1 is directed as light R3 toward a side opposite to the first light source 22R with the object to be detected SUB interposed between the light R1 and the light R3, and reaches the sensor panel 10. In this case, as illustrated in “Third Lighting Pattern”, part of the light B1 emitted from the third light source 22B toward the object to be detected SUB is reflected by the object to be detected SUB and scattered as light B2. Part of the light B1 is directed as light B3 toward a side opposite to the third light source 22B with the object to be detected SUB interposed between the light B1 and the light B3, and reaches the sensor panel 10. However, in this case, as illustrated in “Second Lighting Pattern”, the light G1 emitted from the second light source 22G toward the object to be detected SUB is mostly absorbed by the object to be detected SUB because the object to be detected SUB is purple, and practically does not reach the sensor panel 10. Thus, among the light from the first light source 22R, the light from the second light source 22G, and the light from the third light source 22B, the light that reaches the sensor panel 10 depends on the color of the object to be detected SUB.

In the embodiment, the PD 82 of the sensor WA detects the level of intensity of light and does not identify the color of light. Therefore, in the embodiment, as illustrated in FIG. 6, for example, a period in which the first light source 22R is on as illustrated in “First Lighting Pattern”, a period in which the second light source 22G is on as illustrated in “Second Lighting Pattern”, and a period in which the third light source 22B is on as illustrated in “Third Lighting Pattern” are individually provided. With these periods, detection results of the light according to the color of the object to be detected SUB are obtained. That is, in the embodiment, the sensor scan is performed for each of “First Lighting Pattern”, “Second Lighting Pattern”, and “Third Lighting Pattern”. The results of these sensor scans are then integrated to obtain an output of the sensor scans including color information according to the color of the object to be detected SUB. Hereafter, the term “data integration” refers to the integration of the results of such sensor scans for obtaining the output of the sensor scans that includes the color information according to the color of the object to be detected SUB. The data integration reflects adjustment coefficients of signal strengths to be described later.

In the example illustrated in FIG. 6, light reaching the sensor panel 10 is generated in “First Lighting Pattern” and “Third Lighting Pattern” and light reaching the sensor panel 10 is not generated in “Second Lighting Pattern”. However, this is merely exemplary and does not indicate that this is always the case in “First Lighting Pattern”, “Second Lighting Pattern”, and “Third Lighting Pattern”.

When a “first output” refers to an output of the optical sensor WA corresponding to a period when light in a first color (such as red (R)) is emitted, “First Lighting Pattern” illustrated in FIG. 6 indicates a lighting pattern of the light source unit 22 from which the first output is obtained. When a “second output” refers to an output of the optical sensor WA corresponding to a period when light in a second color (such as green (G)) is emitted, “Second Lighting Pattern” illustrated in FIG. 6 indicates a lighting pattern of the light source unit 22 from which the second output is obtained. When a “third output” refers to an output of the optical sensor WA corresponding to a period when light in a third color (such as blue (B)) is emitted, “Third Lighting Pattern” illustrated in FIG. 6 indicates a lighting pattern of the light source unit 22 from which the third output is obtained.

As described with reference to FIG. 1, a plurality of the light source units 22 are arranged in the light-emitting area LA. As described with reference to FIG. 5, each of the light source units 22 includes the first light source 22R, the second light source 22G, and the third light source 22B. Therefore, in the embodiment, a plurality of the first light sources 22R, a plurality of the second light sources 22G. and a plurality of the third light source 22B are provided.

The first light source 22R, the second light source 22G, and the third light source 22B of each of the light source units 22 can differ from one another in luminance. For example, in general, when the light sources that have the same configuration except for the color of light that they emit, are lit under the same power supply conditions, the light from the green (G) light source tends to be brighter than the light from the red (R) light source and the light from the blue (B) light source. The light-receiving sensitivity of the optical sensor WA may also reflect such a characteristic.

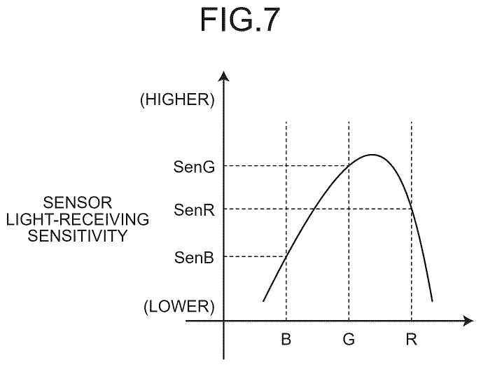

FIG. 7 is a schematic graph illustrating a case where a correspondence relation between the type of the light source emitting light and the light-receiving sensitivity of the optical sensor WA is relatively compared by the high/low level of the light-receiving sensitivity. The PD 82 of the optical sensor WA exhibits the light-receiving sensitivity depending on the wavelength of the irradiating light. Hereafter, first sensitivity SenR refers to the light-receiving sensitivity of the PD 82 with respect to the wavelength of the light from the first light source 22R. Second sensitivity SenG refers to the light-receiving sensitivity of the PD 82 with respect to the wavelength of the light from the second light source 22G. Third sensitivity SenB refers to the light-receiving sensitivity of the PD 82 with respect to the wavelength of the light from the third light source 22B. As illustrated in FIG. 7, the second sensitivity SenG is higher than the first sensitivity SenR and the third sensitivity SenB. The first sensitivity SenR is higher than the third sensitivity SenB. Thus, values of the light-receiving sensitivity of the PD 82 to the light emitted from the first light source 22R, the second light source 22G, and the third light source 22B differ from one another.

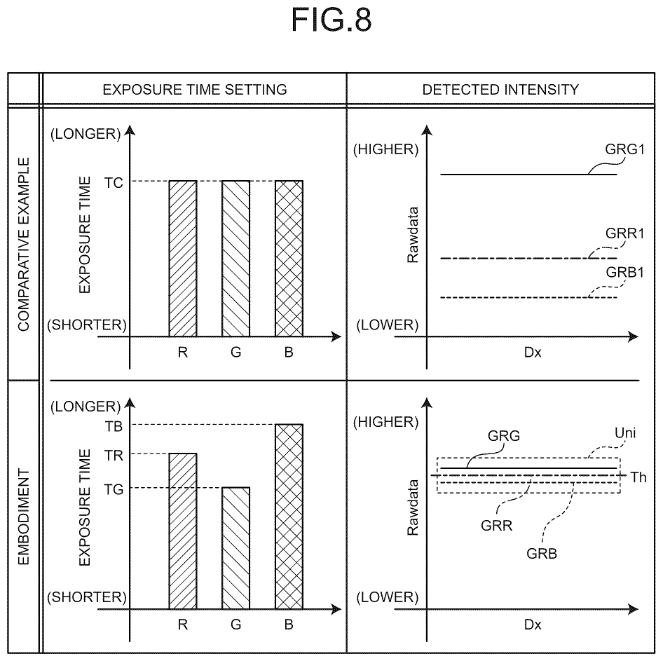

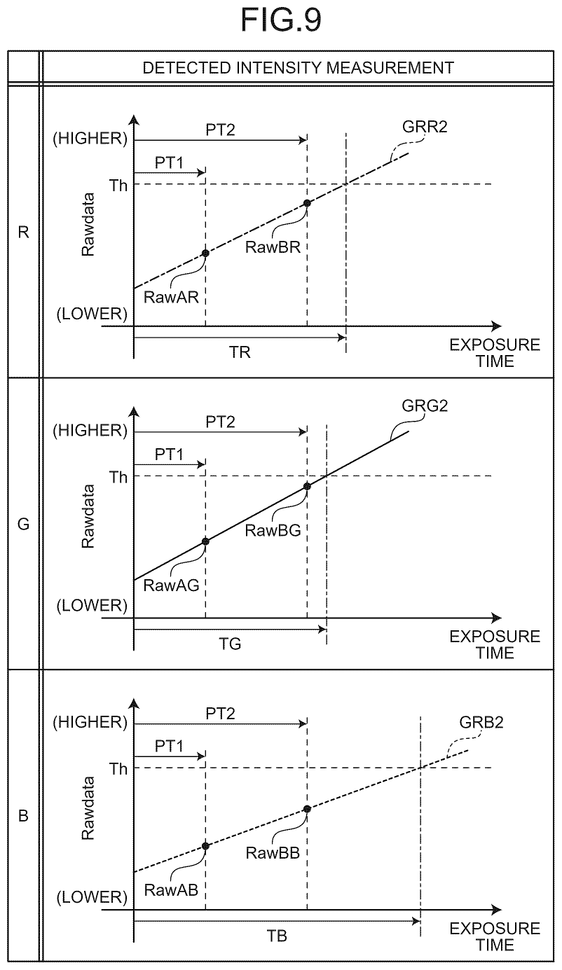

FIG. 8 illustrates diagrams schematically illustrating relations between the exposure time and the detected intensity of light indicated by a signal output by the PD 82. Hereinafter, the term “first detected intensity” refers to the detected intensity of the light indicated by the signal output by the PD 82 when the light from the first light source 22R is detected by the PD 82. The term “second detected intensity” refers to the detected intensity of the light indicated by the signal output by the PD 82 when the light from the second light source 22G is detected by the PD 82. The term “third detected intensity” refers to the detected intensity of the light indicated by the signal output by the PD 82 when the light from the third light source 22B is detected by the PD 82. The term simply called “detected intensity” refers to the detected intensity of the light indicated by the signal output by the PD 82. In FIG. 8 and in FIG. 9 to be explained later, the high/low level of the detected intensities are indicated by the high/low level of “Rawdata”. In the following description, a “first exposure time” refers to a time in which the PD 82 can detect the light from the first light source 22R. A “Second exposure time” refers to a time in which the PD 82 can detect the light from the second light source 22G. A “Third exposure time” refers to a time in which the PD 82 can detect the light from the third light source 22B. In a comparative example illustrated in FIG. 8, the first, the second, and the third exposure times are unified as a common exposure time TC. In contrast, in the embodiment illustrated in FIG. 8, the first exposure time TR, the second exposure time TG, and the third exposure time TB are set individually.

As illustrated in column “Exposure Time Setting” of “Comparative Example” in FIG. 8, when the first, the second, and the third exposure times are unified as the common exposure time TC, differences in detected intensity occur according to differences between the first sensitivity SenR, the second sensitivity SenG, and the third sensitivity SenB. Specifically, a second detected intensity GRG1 is higher than a first detected intensity GRR1 and a third detected intensity GRB1, as illustrated in column “Detected Intensity” of “Comparative Example” in FIG. 8. The first detected intensity GRR1 is higher than the third detected intensity GRB1.

In contrast, the embodiment is provided with a mechanism to make the detected intensity nearly constant regardless of which of the light sources has emitted the light. Specifically, the first exposure time TR, the second exposure time TG, and the third exposure time TB differ from one another, as illustrated in “Exposure Time Setting” of “Embodiment” in FIG. 8. The second exposure time TG is shorter than the first exposure time TR and the third exposure time TB. The first exposure time TR is shorter than the third exposure time TB.

Thus, in the embodiment, as the light-receiving sensitivity for light to be detected by the PD 82 is higher, the exposure time in which the PD 82 can detect the light is set shorter. This setting allows the first detected intensity GRR, the second detected intensity GRG, and the third detected intensity GRB to fall within a range Uni, as illustrated in column “Detected Intensity” of “Embodiment”. That is, in the embodiment, the detected intensity is nearly constant regardless of which of the light sources has emitted the light. In other words, in the embodiment, the first exposure time TR, the second exposure time TG, and the third exposure time TB are set so as to make the detected intensity almost equal regardless of which of the light sources has emitted the light. In the example illustrated in FIG. 8, the first detected intensity GRR matches a target value Th to be described later, but this is not a requirement and is merely an example.

The following describes a mechanism to determine each of the first exposure time TR, the second exposure time TG, and the third exposure time TB, with reference to FIG. 9.

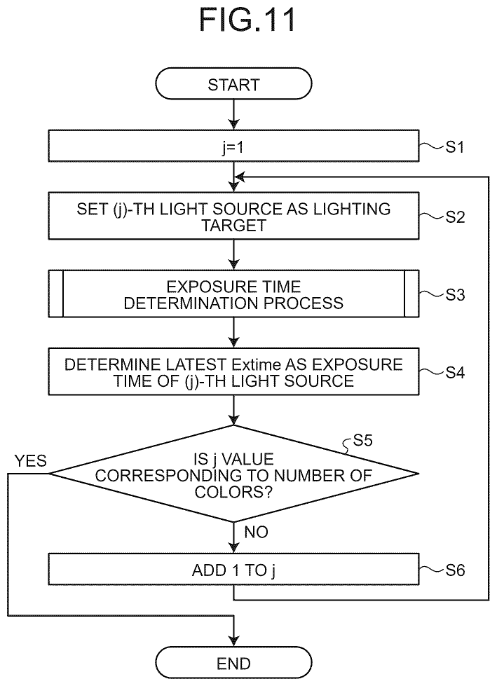

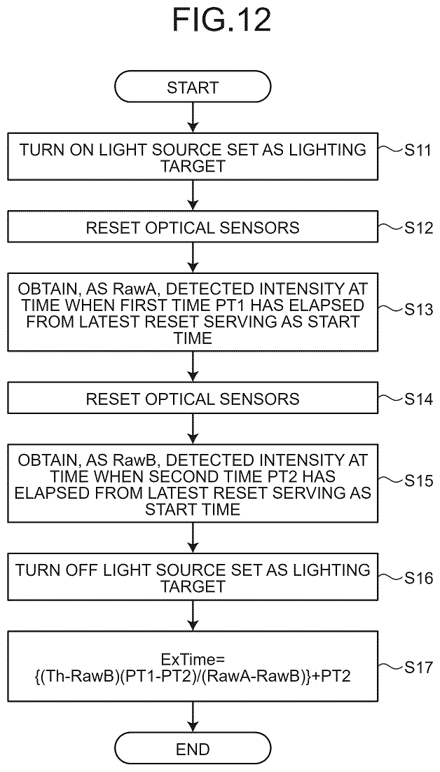

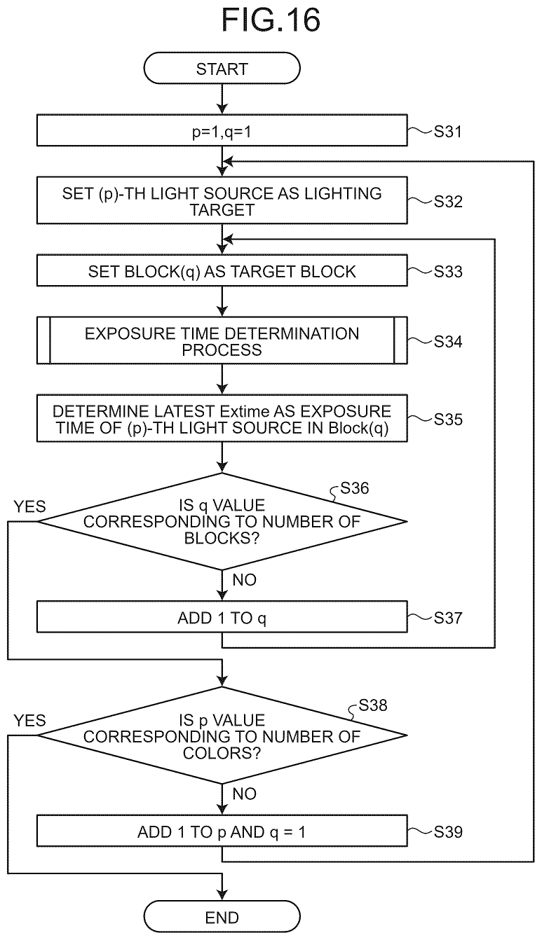

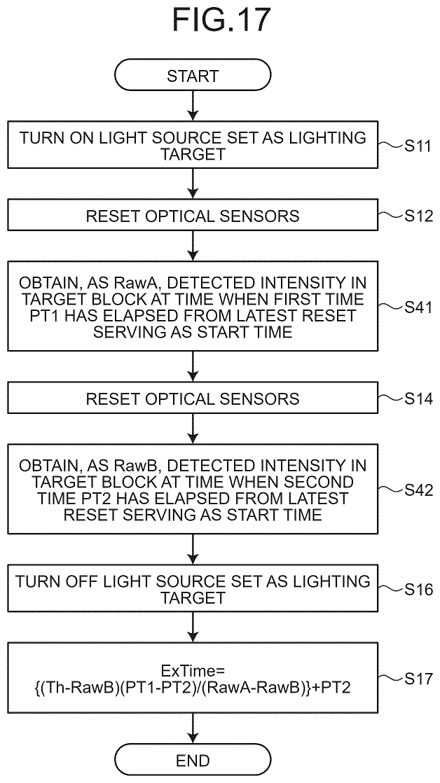

FIG. 9 illustrates schematic diagrams illustrating the mechanism to determine the first exposure time TR, the second exposure time TG, and the third exposure time TB that are the exposure times during each of which the detected intensity reaches the target value Th. When determining each of the first exposure time TR, the second exposure time TG, and the third exposure time TB, the following state is prepared based on the mechanism described with reference to FIGS. 4 to 6: light is emitted from the light source panel 20 to the sensor panel 10; the light is detected by the PD 82 of the sensor panel 10; and a detection signal is output from the optical sensor WA including the PD 82. However, unlike FIGS. 4 and 6, the object to be detected SUB is not disposed between the sensor panel 10 and the light source panel 20. That is, when determining each of the first exposure time TR, the second exposure time TG, and the third exposure time TB, a state is prepared where the light from the light source panel 20 can reach the sensor panel 10 without being affected by the object to be detected SUB. Therefore, while a process to determine each of the exposure times for the light sources, such as the first exposure time TR, the second exposure time TG, and the third exposure time TB, is being performed, the light from the light source panel 20 is directly emitted to the sensor panel 10. A process to be described later with reference to FIGS. 11 and 12 and a process to be described later with reference to FIGS. 16 and 17 correspond to the process to determine the exposure times for the respective light sources.

In the prepared state described above, the first exposure time TR, the second exposure time TG, and the third exposure time TB are individually determined. The determination of the first exposure time TR will first be described with reference to row “R” in FIG. 9.

When determining the first exposure time TR, the first light source 22R is turned on with the output of the PD 82 being reset. As the first-time process, the output from the optical sensor WA is obtained when a first time PT1 has elapsed since the start of the lighting of the first light source 22R. In row “R” in FIG. 9, the detected intensity indicated by the first-time output is a first intensity RawAR. After the output of the PD 82 by the first-time process is obtained, the first light source 22R is turned off and the output of the PD 82 is reset. After the output of the PD 82 is reset, the first light source 22R is turned on again. As the second-time process, the output from the optical sensor WA is obtained when a second time PT2 has elapsed since the start of the lighting of the first light source 22R. The second time PT2 is longer than the first time PT1. In row “R” in FIG. 9, the detected intensity indicated by the second-time output is a second intensity RawBR.

The first exposure time TR can be determined based on the first time PT1, the second time PT2, the first intensity RawAR, and the second intensity RawBR. Specifically, as illustrated in row “R” in FIG. 9, the degree of increase in the detected intensity with the exposure time can be calculated based on the relation between the length of the first time PT1 and the length of the second time PT2 and the relation between the first intensity RawAR and the second intensity RawBR. In row “R” in FIG. 9, the degree of increase in the detected intensity with the exposure time is illustrated as a graph GRR2 with the exposure time as the horizontal axis and the detected intensity as the vertical axis. The time indicated by a coordinate in the horizontal axis direction corresponding to an intersection between the graph GRR2 and the target value Th on the vertical axis is the first exposure time TR.

The second exposure time TG and the third exposure time TB can be determined by the same mechanism as that for the first exposure time TR.

When determining the second exposure time TG, the second light source 22G is turned on with the output of the PD 82 being reset. As the first-time process, the output from the optical sensor WA is obtained when the first time PT1 has elapsed since the start of the lighting of the second light source 22G. In row “G” in FIG. 9, the detected intensity indicated by the first-time output is a first intensity RawAG. After the output of the PD 82 by the first-time process is obtained, the second light source 22G is turned off and the output of the PD 82 is reset. After the output of the PD 82 is reset, the second light source 22G is turned on again. As the second-time process, the output from the optical sensor WA is obtained when the second time PT2 has elapsed since the start of the lighting of the second light source 22G. In row “G” in FIG. 9, the detected intensity indicated by the second-time output is a second intensity RawBG.

The second exposure time TG can be determined based on the first time PT1, the second time PT2, the first intensity RawAG, and the second intensity RawBG. Specifically, as illustrated in row “G” in FIG. 9, the degree of increase in the detected intensity with the exposure time can be calculated based on the relation between the length of the first time PT1 and the length of the second time PT2 and the relation between the first intensity RawAG and the second intensity RawBG. In row “G” in FIG. 9, the degree of increase in the detected intensity with the exposure time is illustrated as a graph GRG2 with the exposure time as the horizontal axis and the detected intensity as the vertical axis. The time indicated by a coordinate in the horizontal axis direction corresponding to an intersection between the graph GRG2 and the target value Th on the vertical axis is the second exposure time TG.

When determining the third exposure time TB, the third light source 22B is turned on with the output of the PD 82 being reset. As the first-time process, the output from the optical sensor WA is obtained when the first time PT1 has elapsed since the start of the lighting of the third light source 22B. In row “B” in FIG. 9, the detected intensity indicated by the first-time output is a first intensity RawAB. After the output of the PD 82 by the first-time process is obtained, the third light source 22B is turned off and the output of the PD 82 is reset. After the output of the PD 82 is reset, the third light source 22B is turned on again. As the second-time process, the output from the optical sensor WA is obtained when the second time PT2 has elapsed since the start of the lighting of the third light source 22B. In row “B” in FIG. 9, the detected intensity indicated by the second-time output is a second intensity RawBB.

The third exposure time TB can be determined based on the first time PT1, the second time PT2, the first intensity RawAB, and the second intensity RawBB. Specifically, as illustrated in row “B” in FIG. 9, the degree of increase in the detected intensity with the exposure time can be calculated based on the relation between the length of the first time PT1 and the length of the second time PT2 and the relation between the first intensity RawAB and the second intensity RawBB. In row “B” in FIG. 9, the degree of increase in the detected intensity with the exposure time is illustrated as a graph GRB2 with the exposure time as the horizontal axis and the detected intensity as the vertical axis. The time indicated by a coordinate in the horizontal axis direction corresponding to an intersection between the graph GRB2 and the target value Th on the vertical axis is the third exposure time TB.

As illustrated in FIGS. 8 and 9, the second exposure time TG is shorter than the first exposure time TR and the third exposure time TB. The first exposure time TR is shorter than the third exposure time TB. This is because the second sensitivity SenG is higher than the first sensitivity SenR and the third sensitivity SenB, and the first sensitivity SenR is higher than the third sensitivity SenB. That is, to equalize the detected intensities corresponding to the outputs of the PDs 82 that are individually irradiated with the light from the respective light sources, which emit light having different wavelengths, the exposure time is set shorter for light having wavelengths with higher light-receiving sensitivity by the PD 82.

When each of the first exposure time TR, the second exposure time TG, and the third exposure time TB is determined, the object to be detected SUB is not located between the sensor panel 10 and the light source panel 20.

The target value Th is preset as a target value in the process of determining the exposure time for each of the light source. That is, the target value Th is preset as a target value of the output of the optical sensor WA under conditions where an object to be detected, such as the object to be detected SUB, is not placed between the sensor panel 10 and the light source panel 20. In the embodiment, the target value Th is 95% of a range (0% to 100%) that the output of the optical sensor WA can take, but the target value Th is not limited to this range and can be changed as appropriate. The target value Th is preferably within a relatively high-output partial range in the range of the output producible by the optical sensor WA. The range of the output producible by the optical sensor WA in the embodiment is a range of output in which 0% represents a state where the PD 82 is reset and does not detect any light and 100% represents a state where the output of the PD 82 is saturated. The relatively high-output partial range refers to, for example, a range from 90% to 100% of the range of the output producible by the optical sensor WA.

By setting the target value Th in this way, the first, the second, and the third detection intensities fall within the range Uni described with reference to FIG. 8. That is, the output of the optical sensor WA under the conditions where an object to be detected, such as the object to be detected SUB, is not placed, becomes an output corresponding to the target value Th, regardless of the color of the light emitted by the light source that is on. In actual operations of the detection device, even if the exposure times (such as the first exposure time TR, the second exposure time TG, and the third exposure time TB) of the respective light sources are set based on the target value Th, the detected intensities, such as the first detected intensity, the second detected intensity, and the third detected intensity, of the respective light sources does not always perfectly become the detected intensities corresponding to the target value Th, due to various error factors. However, by setting the exposure times (such as the first exposure time TR, the second exposure time TG, and the third exposure time TB) of the respective light sources based on the target value Th as described with reference to FIG. 9, the detected intensity of each of the light sources can fall within a detected intensity range that can be regarded to be substantially equivalent, such as the range Uni. The range Uni is, for example, within a high/low level error 5% of the detected intensity with respect to the target value Th, but the error is not limited to 5% and may be changed as appropriate according to the required accuracy.

The following describes an operation of the detection device 1 that reflects the first exposure time TR, the second exposure time TG, and the third exposure time TB, with reference to FIG. 10.

FIG. 10 is a timing diagram schematically illustrating the operation of the detection device 1 that reflects the first exposure time TR, the second exposure time TG, and the third exposure time TB. In the description with reference to FIG. 10, a frame period FR refers to a period when any one of the first light source 22R, the second light source 22G, and the third light source 22B is on, and resetting of the PD 82 in the optical sensor WA and outputting from the optical sensor WA after the resetting are performed. Section “R” in FIG. 10 illustrates a timing diagram in a period when the first light source 22R is on and the second and the third light sources 22G and 22B are off. Section “G” illustrates a timing diagram in a period when the second light source 22G is on and the first and the third light sources 22R and 22B are off. Section “B” illustrates a timing diagram in a period when the third light source 22B is on and the first and the second light sources 22R and 22G are off. The frame period FR includes a sub-frame period SF1 and a sub-frame period SF2. The sub-frame period SF1 is a period when the PD 82 is reset. The sub-frame period SF2 is a period when the outputting from the optical sensor WA is performed.

The resetting of the PD 82 in the sub-frame period SF1 and the outputting from the optical sensor WA in the sub-frame period SF2 are performed sensor-row by sensor-row. The term “sensor row” refers to the optical sensors WA that share one reset signal transmission line 5 and one scan line 6 with one another. For example, in FIG. 2, the optical sensors WA that share the reset signal transmission line 51 and the scan line 61 with one another constitute one sensor row. The optical sensors WA that share the reset signal transmission line 52 and the scan line 62 with one another in FIG. 2 constitute one sensor row. Thus, in the embodiment, the optical sensors WA that constitute one sensor row are arranged in the first direction Dx.

FIG. 10 illustrates signal waveforms PL1, PL2, PL3, . . . , PLn and signal waveforms QL1, QL2, QL3, . . . , QLn in order to distinguish control timing for each sensor row. The signal waveforms PL1 and QL1 indicate waveforms of signals for a sensor row (first sensor row) composed of the optical sensors WA that share the reset signal transmission line 51 and the scan line 61 with one another. The signal waveforms PL2 and QL2 indicate waveforms of signals for a sensor row (second sensor row) composed of the optical sensors WA that share the reset signal transmission line 52 and the scan line 62 with one another. The signal waveforms PL3 and QL3 indicate waveforms of signals for a sensor row (third sensor row) located on the opposite side to the reset signal transmission line 51 with the reset signal transmission line 52 interposed therebetween in FIG. 2. The signal waveforms PLn and QLn indicate waveforms of signals for a sensor row (nth sensor row) composed of the optical sensors WA that share the reset signal transmission line 5n and the scan line 6n with one another. Although not illustrated, signal outputs for control for respective sensor rows also are produced between the signal waveforms PL3 and PLn, depending on the number of the sensor rows.

FIG. 10 individually illustrates the reset signal during the sub-frame period SF1 and the readout signal during sub-frame period SF2. The reset signal is given to the reset signal transmission line 5. The readout signal is given to the scan line 6. For example, a signal corresponding to the signal waveform PL1 that represents the reset signal is given to the reset signal transmission line 51. A signal corresponding to the signal waveform QL1 that represents the readout signal is given to the scan line 61.

The frame period FR in which the first light source 22R is turned on starts at the time of a start pulse ST1 illustrated in FIG. 10. After the start pulse ST1, the signal waveform PL1 becomes high (on) from low (off) and then becomes low (off) again at time Ra1. At time Ra1, the PD 82 of each of the optical sensors WA constituting the first sensor row is reset. The signal waveform QL1 becomes high (on) from low (off) and then becomes low (off) again at time Rb1 after the elapse of the first exposure time TR from time Ra1. At time Rb1, the outputs from the optical sensors WA constituting the first sensor row are transmitted to the detection circuit 15 via the multiplexer 40.

The signal waveform PL2 becomes high (on) from low (off) and then becomes low (off) again at time Ra2 after time Ra1. At time Ra2, the PD 82 of each of the optical sensors WA constituting the second sensor row is reset. The signal waveform QL2 becomes high (on) from low (off) and then becomes low (off) again at time Rb2 after the elapse of the first exposure time TR from time Ra2. At time Rb2, the outputs from the optical sensors WA constituting the second sensor row are transmitted to the detection circuit 15 via the multiplexer 40.

Thereafter, in the same way, the signal waveform PL3 becomes high (on) from low (off) and then becomes low (off) again at time Ra3 after time Ra2. The signal waveform QL3 becomes high (on) from low (off) and then becomes low (off) again at time Rb3 after the elapse of the first exposure time TR from time Ra3. Thus, the signal waveform PLn becomes high (on) from low (off) before time Ran and then becomes low (off) again at time Ran. The signal waveform QLn becomes high (on) from low (off) and then becomes low (off) again at time Rbn after the elapse of the first exposure time TR from time Ran. Time Ran is the time of the last one of the reset signals that occur during the sub-frame period SF1 of the frame period FR in which the first light source 22R is turned on. Time Rbn is the time of the last one of the readout signals that occur during the sub-frame period SF2 of the frame period FR in which the first light source 22R is turned on.

Times Ra1, Ra2, Ra3, . . . , Ran occur during the sub-frame period SF1. Times Rb1, Rb2, Rb3, . . . , Rbn occur during the sub-frame period SF2. The time between time Ra1 and time Ran is significantly shorter than the first exposure time TR. Therefore, time Rb1 does not occur before time Ran.

Thus, the optical sensors WA constituting each of the sensor rows are provided with the reset signals at different times during the sub-frame period SF1, and provided with the readout signals after the elapse of the exposure time corresponding to the type of light source since being reset. The exposure times for the respective rows are equalized if the type of light source is the same. Therefore, the time difference between the reset signals sequentially provided at times Ra1, Ra2, Ra3, . . . , Ran corresponds to the time difference between the readout signals sequentially provided at times Rb1, Rb2, Rb3, . . . , Rbn. The exposure time corresponding to the type of light source when the first light source 22R is turned on is, for example, the first exposure time TR. The exposure time when the second light source 22G is turned on is the second exposure time TG. The exposure time when the third light source 22B is turned on is the third exposure time TB.

The above has described the signal control related to the resetting of and outputting from the optical sensor WA performed sensor-row by sensor-row, using the frame period FR in which the first light source 22R is turned on as an example. However, the basic concept is the same for the frame periods FR in which other types of light sources are turned on, except that the “exposure time corresponding to the type of the light source” changes.

Specifically, the frame period FR in which the second light source 22G is turned on starts at the time of a start pulse ST2 illustrated in FIG. 10. After the start pulse ST2, the signal waveform PL1 becomes high (on) from low (off) and then becomes low (off) again at time Ga1. At time Ga1, the PD 82 of each of the optical sensors WA constituting the first sensor row is reset. The signal waveform QL1 becomes high (on) from low (off) and then becomes low (off) again at time Gb1 after the elapse of the second exposure time TG from time Ga1. At time Gb1, the outputs from the optical sensors WA constituting the first sensor row are transmitted to the detection circuit 15 via the multiplexer 40. The signal waveform PL2 becomes high (on) from low (off) and then becomes low (off) again at time Ga2 after time Ga1. At time Ga2, the PD 82 of each of the optical sensors WA constituting the second sensor row is reset. The signal waveform QL2 becomes high (on) from low (off) and then becomes low (off) again at time Gb2 after the elapse of the second exposure time TG from time Ga2. At time Gb2, the outputs from the optical sensors WA constituting the second sensor row are transmitted to the detection circuit 15 via the multiplexer 40. Thereafter, in the same way, the signal waveform PL3 becomes high (on) from low (off) and then becomes low (off) again at time Ga3 after time Ga2. The signal waveform QL3 becomes high (on) from low (off) and then becomes low (off) again at time Gb3 after the elapse of the second exposure time TG from time Ga3. Thus, the signal waveform PLn becomes high (on) from low (off) before time Gan and becomes low (off) again at time Gan. The signal waveform QLn becomes high (on) from low (off) and becomes low (off) again at time Gbn after the elapse of the second exposure time TG from time Gan. Time Gan is the time of the last one of the reset signals that occur during the sub-frame period SF1 of the frame period FR in which the second light source 22G is turned on. Time Gbn is the time of the last one of the readout signals that occur during the sub-frame period SF2 of the frame period FR in which the second light source 22G is turned on.

Times Ga1, Ga2, Ga3, . . . . Gan occur during the sub-frame period SF1. Times Gb1, Gb2, Gb3, . . . , Gbn occur during the sub-frame period SF2. The time between time Ga1 and time Gan is significantly shorter than the second exposure time TG. Therefore, time Gb1 does not occur before time Gan.

The frame period FR in which the third light source 22B is turned on starts at the time of a start pulse ST3 illustrated in FIG. 10. After the start pulse ST3, the signal waveform PL1 becomes high (on) from low (off) and then becomes low (off) again at time Ba1. At time Ba1, the PD 82 of each of the optical sensors WA constituting the first sensor row is reset. The signal waveform QL1 becomes high (on) from low (off) and then becomes low (off) again at time Bb1 after the elapse of the third exposure time TB from time Ba1. At time Bb1, the outputs from the optical sensors WA constituting the first sensor row are transmitted to the detection circuit 15 via the multiplexer 40. The signal waveform PL2 becomes high (on) from low (off) and then becomes low (off) again at time Ba2 after time Ba1. At time Ba2, the PD 82 of each of the optical sensors WA constituting the second sensor row is reset. The signal waveform QL2 becomes high (on) from low (off) and then becomes low (off) again at time Bb2 after the elapse of the third exposure time TB from time Ba2. At time Bb2, the outputs from the optical sensors WA constituting the second sensor row are transmitted to the detection circuit 15 via the multiplexer 40. Thereafter, in the same way, the signal waveform PL3 becomes high (on) from low (off) and then becomes low (off) again at time Ba3 after time Ba2. The signal waveform QL3 becomes high (on) from low (off) and then becomes low (off) again at time Bb3 after the elapse of the third exposure time TB from time Ba3. Thus, the signal waveform PLn becomes high (on) from low (off) before time Ban and then becomes low (off) again at time Ban. The signal waveform QLn becomes high (on) from low (off) and then becomes low (off) again at time Bbn after the elapse of the third exposure time TB from time Ban. Time Ban is the time of the last one of the reset signals that occur during the sub-frame period SF1 of the frame period FR in which the third light source 22B is turned on. Time Bbn is the time of the last one of the readout signals that occur during the sub-frame period SF2 of the frame period FR in which the third light source 22B is turned on.

Times Ba1, Ba2, Ba3,, Ban occur during the sub-frame period SF1. Times Bb1, Bb2, Bb3, . . . , Bbn occur during the sub-frame period SF2. The time between time Ba1 and time Ban is significantly shorter than the third exposure time TB. Therefore, time Bb1 does not occur before time Ban.

As described above with reference to FIG. 10, the signal control during the frame period FR is substantially the same regardless of the type of the light source, except that the “exposure time corresponding to the type of the light source” (first exposure time TR, second exposure time TG or third exposure time TB) corresponds to the type of the light source that is turned on during the frame period FR.

The start pulses ST1, ST2, and ST3 illustrated in FIG. 10 are not generated at the same timing. Actually, the start pulse ST2 is generated after the sub-frame period SF2 of the frame period FR that starts with the start pulse ST1. The start pulse ST3 is generated after the sub-frame period SF2 of the frame period FR that starts with the start pulse ST2. That is, in FIG. 10, the sections “R”, “G”, and “B” are listed vertically merely for the purpose of clearly indicating time differences between the first exposure time TR, the second exposure time TG, and the third exposure time TB.

In the embodiment, the operation described with reference to FIG. 10 is performed by the detection circuit 15 controlling the reset circuit 13 and the scan circuit 14. Specifically, the operation is performed by the detection circuit 15 controlling the reset circuit 13 and scan circuit 14 such that the length of time between the output timing of the reset signal from the reset circuit 13 and the output timing of the readout signal from the scan circuit 14 becomes the “exposure time corresponding to the type of the light source” (first exposure time TR, second exposure time TG or third exposure time TB). More specifically, the reset circuit 13 and the scan circuit 14 are configured to cause what is called a shift of output by a shift register.

The detection circuit 15 applies control to cause a time interval between first timing and second timing to correspond to the exposure time of each of the light sources. The first timing is timing corresponding to supply timing of a reset signal to the reset signal transmission line 5 to which the reset signal is supplied first. The second timing is timing corresponding to supply timing of a readout signal to the scan line 6 to which the readout signal is supplied first. For example, in the frame period FR in which the first light source 22R is turned on, the detection circuit 15 sets the time between the first timing and the second timing to the first exposure time TR. In the frame period FR in which the second light source 22G is turned on, the detection circuit 15 sets the time between the first timing and the second timing to the second exposure time TG. In the frame period FR in which the third light source 22B is turned on, the detection circuit 15 sets the time between the first timing and the second timing to the third exposure time TB. To give a more specific example, the setting is made such that the frame period FR is periodic, the first timing after the start of the frame period FR is constant, and the second timing varies according to the type of the light source that is turned on. With this setting, a mechanism to obtain the output of the optical sensor WA corresponding to the exposure time according to the type of the light source is achieved. In the embodiment, with the control illustrated as described above, control can be achieved in which the time for the optical sensor to detect light differs among the light sources that emit light in different colors. The “timing corresponding to supply timing” refers to timing when a signal waveform such as a rectangular wave becomes low (off) after the signal waveform becomes high (on) from low (off).

Data indicating the “exposure times corresponding to the types of the light source”, such as the first exposure time TR, the second exposure time TG, and the third exposure time TB, is generated in advance and held by the detection device 1 as described with reference to FIG. 8.

To give a specific example, in the embodiment, the detection circuit 15 is provided with a memory (register) that can store therein a parameter indicating the length of each of the first exposure time TR, the second exposure time TG, and the third exposure time TB. The parameter indicating the length of each of the first exposure time TR, the second exposure time TG, and the third exposure time TB is calculated by information processing by the control circuit 30 based on the mechanism described with reference to FIG. 8. The control circuit 30 writes a value (for example, value corresponding to Extime to be described later) calculated as the parameter to the memory of the detection circuit 15, and thereby, the parameter indicating the length of each of the first exposure time TR, the second exposure time TG, and the third exposure time TB is reflected in the operation of the detection device 1. The calculated value may already be reflected in the memory of the detection circuit 15 at shipment of the detection device 1. That is, the exposure time of each of the multiple types of the light sources emitting light in different colors may be set in advance. In that case, the values in the memory may be non-rewritable or rewritable. In the embodiment, the values in the memory are rewritable. In the embodiment, a mechanism is employed in which the exposure time for each of the multiple types of the light sources emitting light in different colors is determined in an initial operation after the power of the detection device 1 is turned on, that is, after energization is started by turning power on, Specifically, a process described with reference to FIGS. 11 and 12 (or a process described with reference to FIGS. 16 and 17) to be described later is performed as the initial operation after the power of the detection device 1 is turned on.

FIG. 11 is a flowchart illustrating a process related to the determination of the exposure time of each of the light sources. First, a counter for counting the value corresponding to the type of the light source is set to an initial value of 1 (Step S1). In the example illustrated in FIG. 11, j as a variable for the counter is set to the initial value of 1.

After the process at Step S1, the (j)-th light source is set as a lighting target (Step S2). The (j)-th light source refers to the first light source 22R, for example, when j=1. When j=2, the (j)-th light source refers to the second light source 22G. When j=3, the (j)-th light source refers to the third light source 22B. After the process at Step S2, an exposure time determination process is performed (Step S3).

FIG. 12 is a flowchart of the exposure time determination process. First, the light source set as the lighting target by the process at Step S2 is turned on (Step at S11). After the process at Step S11, the optical sensors WA are reset (Step S12). That is, the reset signal resets the PDs 82.

After the process at Step S12, a process is performed to obtain, as a detected intensity RawA, the detected intensity at the time when the first time PT1 has elapsed from the latest reset timing serving as the start timing of the first time PT1 (Step S13). The latest reset timing serving as the start timing as of the time of Step S13 refers to timing of the reset performed in the process at Step S12 immediately before Step S13.

After the process at Step S13, the optical sensors WA are reset (Step S14). That is, the reset signal resets the PDs 82. After the process at Step S14, a process is performed to obtain, as a detected intensity RawB, the detected intensity at the time when the second time PT2 has elapsed from the latest reset timing serving as the start timing of the second time PT2 (Step S15). The latest reset timing serving as the start timing as of the time of Step S15 refers to timing of the reset performed in the process at Step S14 immediately before Step S15.

For example, when j=1, since the first light source 22R is turned on, the detected intensity RawA obtained in the process at Step S13 is regarded as the first intensity RawAR (refer to FIG. 9), and the detected intensity RawB obtained in the process at Step S15 is regarded as the second intensity RawBR (refer to FIG. 9). Under the same concept, when j=2, since the second light source 22G is turned on, the detected intensity RawA obtained in the process at Step S13 is regarded as the first intensity RawAG (refer to FIG. 9), and the detected intensity RawB obtained in the process at Step S15 is regarded as the second intensity RawBG (refer to FIG. 9). When j=3, since the third light source 22B is turned on, the detected intensity RawA obtained in the process at Step S13 is regarded as the first intensity RawAB (refer to FIG. 9), and the detected intensity RawB obtained in the process at Step S15 is regarded as the second intensity RawBB (refer to FIG. 9).

The process from Step S12 to Step S13 and the process from Step S14 to Step S15 are performed sensor-row by sensor-row, in the same way as in the description with reference to FIG. 10. In the embodiment, the plurality of pieces of obtained data are integrated across the entire optical sensors WA provided in the detection area SA for each type of the light sources, that is, for each color of the light emitted by the light sources. That is, the determination of the exposure time of each of the light sources is performed under the conditions where no object to be detected is placed, and the output of the optical sensor WA in the process related to the determination of the exposure time is the average of the outputs of the plurality of optical sensors WA provided in the detection area SA.

After the process at Step S15, the light source set as the lighting target in the process at Step S2 is turned off (Step S16). That is, the light source turned on in the process at Step S11 previously performed is turned off in the process at Step S16.

Extime is calculated as expressed in Expression (1) below (Step S17). Th in Expression (1) is the target value Th. RawA in Expression (1) is the detected intensity RawA obtained in the latest process at Step S13. RawB in Expression (1) is the detected intensity RawB obtained in the latest process at Step S15. PT1 in Expression (1) is the first time PT1 (refer to FIG. 9). PT2 in Expression (1) is the second time PT2 (refer to FIG. 9). The process at Step S16 and the process at Step S17 may be performed in no particular order.

Extime={(Th−RawB)(PT1−PT2)/(RawA−RawB)}+PT2 (1)

After the exposure time determination process described with reference to FIG. 12, that is, the process at Step S3 in FIG. 11, the latest Extime is determined as the exposure time of the (j)-th light source (Step S4). For example, if j=1, Extime is determined as the first exposure time TR. If j=2, Extime is determined as the second exposure time TG. If j=3, Extime is determined as the third exposure time TB.

After the process at Step S4, a determination is made as to whether the value of j is a value corresponding to the number of colors of the light from the light source units 22 (Step S5). The number of colors of the light herein is synonymous with the number of types of the light sources. For example, in the embodiment where the light source panel 20 includes the first light source 22R, the second light source 22G, and the third light source 22B, the number of colors of the light is three. Therefore, the case in which “the value of j is a value corresponding to the number of colors of the light from the light source units 22” is the case where j=3.

If the process at Step S5 determines that the value of j is not a value corresponding to the number of colors of the light from the light source units 22 (No at Step S5), one is added to j (Step S6). After the process at Step S6, the process at Step S2 is performed.

Consequently, the first exposure time TR is set in the processing from Step S2 to Step S4 performed with j=1. The second exposure time TG is set in the processing from Step S2 to Step S4 performed with j=2. The third exposure time TB is set in the processing from Step S2 to Step S4 performed with j=3.

If the process at Step S5 determines that the value of j is a value corresponding to the number of colors of the light from the light source units 22 (Yes at Step S5), the processing described with reference to FIGS. 11 and 12 ends. The thus determined exposure time (such as each of the first exposure time TR, the second exposure time TG, and the third exposure time TB) corresponding to Extime is reflected in the detection circuit 15. As a result, the appropriate exposure time is applied in the sensor scan.

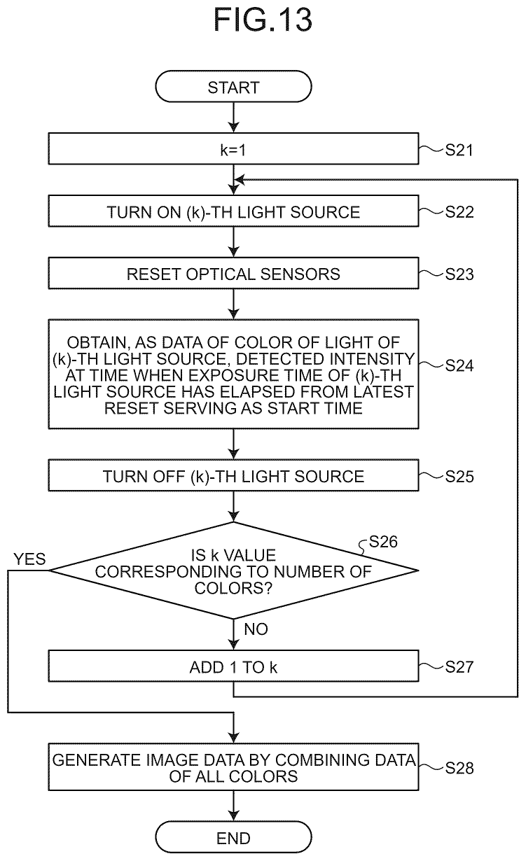

FIG. 13 is a flowchart of the sensor scan. First, a counter for counting the value corresponding to the type of the light source is set to an initial value of 1 (Step S21). In the example illustrated in FIG. 13, k as a variable for the counter is set to the initial value of 1.

After the process at Step S21, the (k)-th light source is turned on (Step S22). The (k)-th light source can be described in the same manner as the description of the (j)-th light source above. After the process at Step S22, the optical sensors WA are reset (Step S23). That is, the reset signal resets the PDs 82.

After the process at Step S23, a process is performed to obtain, as data of the color of the light of the (k)-th light source, the detected intensity at the time when the exposure time of the (k)-th light source has elapsed from the latest reset timing serving as the start timing of the exposure time (Step S24). The latest reset timing serving as the start timing as of the time of Step S24 refers to timing of the reset performed in the process at Step S23 immediately before Step S24.

The process from Step S23 to Step S24 is performed sensor-row by sensor-row, in the same way as in the description with reference to FIG. 10. In the embodiment, the plurality of pieces of obtained data are integrated across the entire optical sensors WA provided in the detection area SA.

After the process at Step S24, the light source turned on in the process at Step S22 is turned off (Step S25). After the process at Step S25, a determination is made as to whether the value of k is a value corresponding to the number of colors of the light from the light source units 22 (Step S26). The concept of the number of colors of the light herein is the same as that in the process at Step S5 described above.

If the process at Step S26 determines that the value of k is not a value corresponding to the number of colors of the light from the light source units 22 (No at Step S26), one is added to k (Step S27). After the process at Step S27, the process at Step S22 is performed.

As a result, the data of the color of the light from the first light source 22R (R data) is obtained by the process from Step S22 to Step S24 performed with k=1. The data of the color of the light from the second light source 22G (G data) is obtained by the process from Step S22 to Step S24 performed with k=2. The data of the color of the light from the third light source 22B (B data) is obtained by the process from Step S22 to Step S24 performed with k=3.

If the process at Step S26 determines that the value of k is a value corresponding to the number of colors of the light from the light source units 22 (Yes at Step S26), a process to generate image data by combining a plurality of pieces of data of all the colors is performed (Step S28). In the embodiment, RGB data is generated by combining the R data, the G data, and the B data described above. When the process at Step S28 ends, the processing described with reference to FIG. 13 ends.

The processes in FIGS. 11 and 12 are performed, for example, by the control circuit 30 controlling the operations of the sensor panel 10 and the light source panel 20. The control for the process at Step S24 in FIG. 13 is performed by the detection circuit 15 based on the exposure time (such as the first exposure time TR, the second exposure time TG, or the third exposure time TB) already reflected in the detection circuit 15. Control other than the control for the process at Step S24 in FIG. 13 is performed, for example, by the control circuit 30 controlling the operations of the sensor panel 10 and the light source panel 20.

As described above, according to the embodiment, the detection device 1 includes the sensor panel (such as the sensor panel 10) that has the detection area (such as the detection area SA) in which the optical sensors (such as the optical sensors WA) are two-dimensionally arranged, the light source units (such as the light source units 22) each including the multiple types of the light sources (such as the first light source 22R, the second light source 22G, and the third light source 22B) that emit light in different colors, the member (such as the light limiting member 50 or a placement member 60) on which the object to be detected is to be placed so as to interpose the object to be detected (such as the object to be detected SUB) between the detection area and the light source units, and the detection circuit (such as the detection circuit 15) that obtains the outputs of the optical sensors. The optical sensor includes the photodiode (such as the PD 82), and obtains an output corresponding to a photocurrent generated corresponding to the light detected by the photodiode. The light sources that emit light in different colors are not turned on simultaneously but are turned on in different periods. The exposure time when the optical sensor detects the light differs between the light sources that emit light in different colors (such as the first exposure time TR, the second exposure time TG, and the third exposure time TB). The output of the optical sensor under the conditions where the object to be detected is not placed falls within an output range (such as the range Uni) corresponding to a predetermined target value (such as the target value Th), regardless of the color of the light emitted by the light source that is turned on. Thus, since the time for the optical sensor to detect light differs between the light sources that emit light in different colors, color calibration within the output range corresponding to the target value is achieved. Therefore, more accurate color reproduction by the color calibration is reflected in the output of the optical sensor in the state where the object to be detected is placed. Thus, according to the embodiment, the detection accuracy of colors can be improved.

The output range (such as the range Uni) is within an output error of 5% with respect to the output of the optical sensor (such as the optical sensor WA) corresponding to the target value (such as the target value Th), so that the detection accuracy of colors can be improved more reliably.

The target value (such as the target value Th) is set within 90% to 100% of the range of the output produced by the optical sensor (such as the optical sensor WA), so that brighter sensor scan results are obtained.

The output of the optical sensor (such as the optical sensor WA) under the conditions where the object to be detected (such as the object to be detected SUB) is not placed is the average of the outputs of the optical sensors provided in the detection area (such as the detection area SA), so that the overall detection accuracy of colors of the sensors can be improved.

The multiple types of the light sources include the first light source (such as the first light source 22R) that emits the light in the first color, the second light source (such as the second light source 22G) that emits the light in the second color, and the third light source (such as the third light source 22B) that emits the light in the third color, thereby improving the detection accuracy of colors in a configuration allowing to obtain color scan results by a combination of the first color, the second color, and the third color.

The exposure times (such as the first exposure time TR, the second exposure time TG, and the third exposure time TB) of the multiple types of the light sources emitting light in different colors are set in advance, so that such exposure times can be applied more reliably and the detection accuracy of colors can be improved more reliably.

By providing the control circuit (such as the control circuit 30) that determines the exposure times of the multiple types of the light sources emitting light in different colors after energization is started by turning power on, more accurate color reproduction by the color calibration based on a more recent state of the detection device 1 can be reflected and the detection accuracy of colors can be improved.

### MODIFICATION

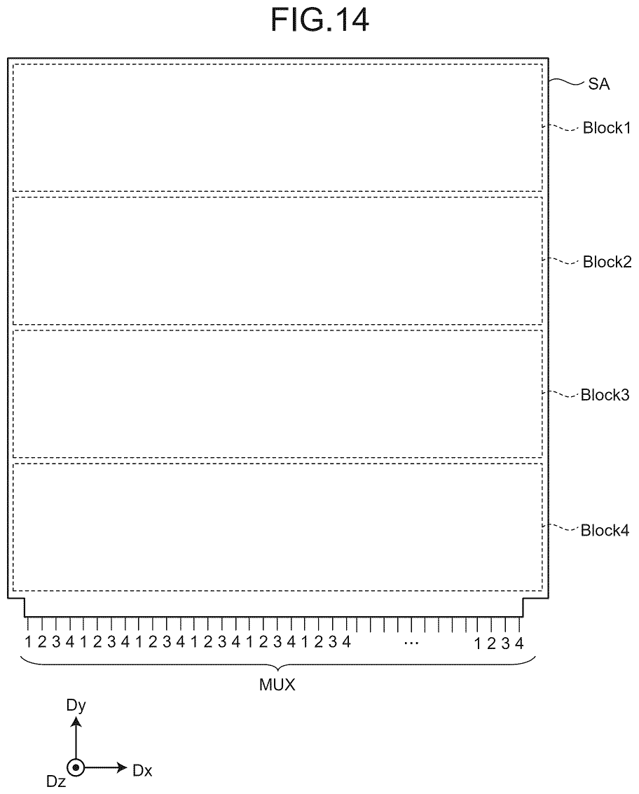

The following describes, with reference to FIGS. 14 to 18, a modification of the embodiment that partially differs from the embodiment described with reference to FIGS. 1 to 10. In the description of the modification, the same matters as those in the embodiment may be denoted by the same reference numerals and the description thereof may be omitted.

FIG. 14 is a schematic view illustrating an example of the number of blocks in the detection area SA and the number of inputs to each multiplexer. In a first modification, the detection area SA is divided into a plurality of divided areas (blocks). In the example illustrated in FIG. 14, the detection area SA is divided into a total of four blocks, Block1, Block2, Block3, and Block4. As illustrated as a sequence of blocks Block1, Block2, Block3, and Block4, the blocks dividing the detection area SA in the first modification are arranged in the second direction Dy. In the first modification, the optical sensors WA provided in the detection area SA are equally or nearly equally divided by the number of the blocks. The blocks include the same number or nearly the same number of the optical sensors WA.

In the modification, n is preferably a multiple of the number of blocks. If n is a multiple of the number of blocks, the number of the reset signal transmission lines 5 and the number of the scan lines 6 included in each of the blocks is a number obtained by dividing n by the number of blocks. However, each of the blocks need not include exactly the same number of the optical sensors WA. Some of the blocks may have more of the optical sensors WA than other blocks. The number of the blocks is not limited to four, and only needs to be a natural number equal to or larger than two.

In the modification, the grouping according to the number of inputs to the multiplexer is further applied. The term “number of inputs to the multiplexer” herein is the number of the switches (such as the switches SW1, SW2, SW3, and SW4) included in the multiplexer 40 described with reference to FIG. 2. FIG. 14 illustrates the grouping according to the number of inputs to the multiplexer by numerics “1”, “2”, “3”, and “4” as multiplexer inputs MUX. The multiplexer input MUX with the numeric “1” indicates the signal line 7 coupled to the switch SW1. The multiplexer input MUX with the numeric “2” indicates the signal line 7 coupled to the switch SW2. The multiplexer input MUX with the numeric “3” indicates the signal line 7 coupled to the switch SW3. The multiplexer input MUX with the numeric “4” indicates the signal line 7 coupled to the switch SW4. In the embodiment and various modifications including the first modification, the number of inputs to each multiplexer is not limited to four, and only needs to be a natural number equal to or larger than two.

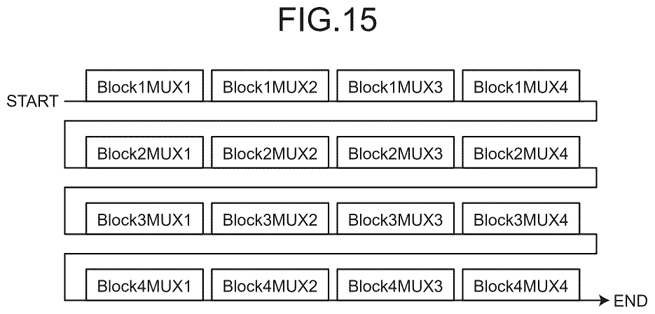

FIG. 15 is a diagram illustrating an exemplary individual detection process based on combinations of the blocks with the inputs to each multiplexer. In the first modification, the outputs of the optical sensors WA in the scan process are grouped based on the combinations of the blocks with the inputs to each multiplexer. FIG. 15 illustrates that the scan process starts from “Block1MUX1”, and the scan process sequentially proceeds in the order of “Block1MUX2”, “Block1MUX3”, “Block1MUX4”, “Block2MUX1”, “Block2MUX2”, “Block2MUX3”, “Block2MUX4”, “Block3MUX1”, “Block3MUX2”, “Block3MUX3”, “Block3MUX4”, “Block4MUX1”, “Block4MUX2”, “Block4MUX3”, and “Block4MUX4”, and ends when the scan process “Block4MUX4” is completed.

“Block1MUX1” refers to the optical sensors WA included in the block Block1, and refers to the optical sensors WA between which the signal line 7 coupled to the switch SW1 is shared. “Block1MUX2” refers to the optical sensors WA included in the block Block1, and refers to the optical sensors WA between which the signal line 7 coupled to the switch SW2 is shared. “Block2MUX1” refers to the optical sensors WA included in the block Block2, and refers to the optical sensors WA between which the signal line 7 coupled to the switch SW1 is shared. Thus, in the notation of “Block(q)MUX(r)”, (q) is a natural number and takes a value in a range not exceeding the number of blocks. (r) is a natural number and takes a value in a range not exceeding the number of the inputs to the multiplexer. That is, “Block(q)MUX(r)” refers to the optical sensors WA that are included in Block(q) and between which the signal line 7 coupled to the switch SW(r) is shared. In the case of the example illustrated in FIG. 14, (q) and (r) each take any one of values 1, 2, 3, and 4.

In the configuration example described with reference to FIG. 14, “Block1MUX1”, “Block1MUX2”, “Block1MUX3”, “Block1MUX4”, “Block2MUX1”, “Block2MUX2”, “Block2MUX3”, “Block2MUX4”, “Block3MUX1”, “Block3MUX2”, “Block3MUX3”, “Block3MUX4”, “Block4MUX1”, “Block4MUX2”, “Block4MUX3”, and “Block4MUX4” cover different partial areas of the detection area SA. For example, “Block1MUX1” can be handled as a partial area of the detection area SA consisting of sensor rows included in the block Block1 and sensor columns coupled to the switch SW1. The total of all outputs of these 16 partial areas is synonymous with the output of the entire detection area SA.

In the process of scanning “Block(q)MUX(r)”, the readout signals are supplied to the scan lines 6 included in the block Block(q) and no readout signals are supplied to the other scan lines 6. In the process of scanning “Block(q)MUX(r)”, the switch SW(r) is turned on (conducting state), and switches other than the switch SW(r) provided in the multiplexer 40 are turned off (non-conducting state). In this way, the output limited to the output from the optical sensor WA indicated by “Block(q)MUX(r)” can be obtained.

In the modification, the exposure times, such as the first exposure time TR, the second exposure time TG, and the third exposure time TB described above, are individually set block by block. The following describes the block-by-block determination of the exposure times and the sensor scan after the determination, with reference to FIGS. 16 to 18.

FIG. 16 is a flowchart illustrating a process related to the determination of the exposure time of each of the light sources in the modification. First, counters for counting values corresponding to the type of the light source and the number of the divided areas (blocks) are set to an initial value of 1 (Step S31). In the example illustrated in FIG. 16, p is set as a variable for counting the type of the light source. q is set as a variable for counting the number of the divided areas (blocks).

After the process at Step S31, the (p)-th light source is set as a lighting target (Step S32). The (p)-th light source can be described in the same manner as the description of the (j)-th light source above. Block(q) is set as a target block (Step S33). For example, when q=1, Block(q) indicates the block Block1. The process at Step S32 and the process at Step S33 may be performed in no particular order. After the processes at Steps S32 and S33, the exposure time determination process is performed (Step S34).

FIG. 17 is a flowchart illustrating a process of the exposure time determination process in the modification. First, the same processes as those at Steps S11 and S12 described with reference to FIG. 12 are performed. Then, a process is performed to obtain, as the detected intensity RawA, the detected intensity in Block(q), which is the detected intensity at the time when the first time PT1 has elapsed from the latest reset timing serving as the start timing of the first time PT1 (Step S41). The latest reset timing serving as the start timing as of the time of Step S41 refers to timing of the reset performed in the process at Step S12 immediately before Step S41. The process at Step S41 differs from the process at Step S13 described with reference to FIG. 12 in the area from which the detected intensity is to be obtained. Specifically, the area from which the detected intensity is to be obtained is limited to Block(q) at Step S41 and the entire detection area SA at Step S13.

After the process at Step S41, the same process as the process at Step S14 described with reference to FIG. 12 is performed. Then, a process is performed to obtain, as the detected intensity RawB, the detected intensity in Block(q), which is the detected intensity at the time when the second time PT2 has elapsed from the latest reset timing serving as the start timing of the second time PT2 (Step S42). The latest reset timing serving as the start timing as of the time of Step S42 refers to timing of the reset performed in the process at Step S14 immediately before Step S42. The process at Step S42 differs from the process at Step S15 described with reference to FIG. 12 in the area from which the detected intensity is to be obtained. Specifically, the area from which the detected intensity is to be obtained is limited to Block(q) at Step S42 and the entire detection area SA at Step S15.

After the process at Step S42, the same processes as those at Steps S16 and S17 described with reference to FIG. 12 are performed. Extime calculated in the process at Step S17 in the modification is Extime of Block(q) in the state where the (p)-th light source is on. For example, if q=1, Extime of the block Block1 is calculated. If q=2, Extime of the block Block2 is calculated. If q=3, Extime of the block Block3 is calculated. If q=4, Extime of the block Block4 is calculated.

The process from Step S12 to Step S41 and the process from Step S14 to Step S42 are performed sensor-row by sensor-row, in the same way as in the description with reference to FIG. 10. In the modification, the plurality of pieces of obtained data are integrated Block(q) by Block(q).

After the exposure time determination process described with reference to FIG. 17, that is, the process at Step S34 in FIG. 16, the latest Extime is determined as the exposure time of the (p)-th light source in Block(q) (Step S35). For example, if p=1 and q=1, Extime is determined as the first exposure time TR in the block Block1.

After the process at Step S35, a determination is made as to whether the value of q is a value corresponding to the number of the blocks (Step S36). For example, in the example described with reference to FIG. 14, the number of the blocks is four. Therefore, the case where “the value of q is a value corresponding to the number of the blocks” is the case where q=4.

If the process at Step S36 determines that the value of q is not a value corresponding to the number of the blocks (No at Step S36), one is added to q (Step S37). After the processes at Step S37, the process at Step S33 is performed.

As a result, the exposure time of the (p)-th light source in the block Block1 is set by the process from Step S33 to Step S35 performed with q=1. The exposure time of the (p)-th light source in the block Block2 is set by the process from Step S33 to Step S35 performed with q=2. The exposure time of the (p)-th light source in the block Block3 is set by the process from Step S33 to Step S35 performed with q=3. The exposure time of the (p)-th light source in the block Block4 is set by the process from Step S33 to Step S35 performed with q=4.

If the process at Step S36 determines that the value of q is a value corresponding to the number of the blocks (Yes at Step S36), a determination is made as to whether the value of p is a value corresponding to the number of colors of the light from the light source units 22 (Step S38). The concept of the number of colors of the light herein is the same as that in the process at Step S5 described above. If the process at Step S38 determines that the value of p is not a value corresponding to the number of colors of the light from the light source units 22 (No at Step S38), one is added to p and the value of q is initialized to be set to one (Step S39). After the process at Step S39, the process at Step S32 is performed.

As a result, the first exposure time TR of each of the blocks is set by the process from Step S32 to Step S35 performed with p=1. The second exposure time TG of each of the blocks is set by the process from Step S32 to Step S35 performed with p=2. The third exposure time TB of each of the blocks is set by the process from Step S32 to Step S35 performed with p=3.

If the process at Step S38 determines that the value of p is a value corresponding to the number of colors of the light from the light source units 22 (Yes at Step S38), the processing described with reference to FIGS. 16 and 17 ends. The thus determined exposure time (such as each of the first exposure time TR, the second exposure time TG, and the third exposure time TB) corresponding to Extime is reflected in the detection circuit 15. As a result, the appropriate exposure time is applied in the sensor scan.

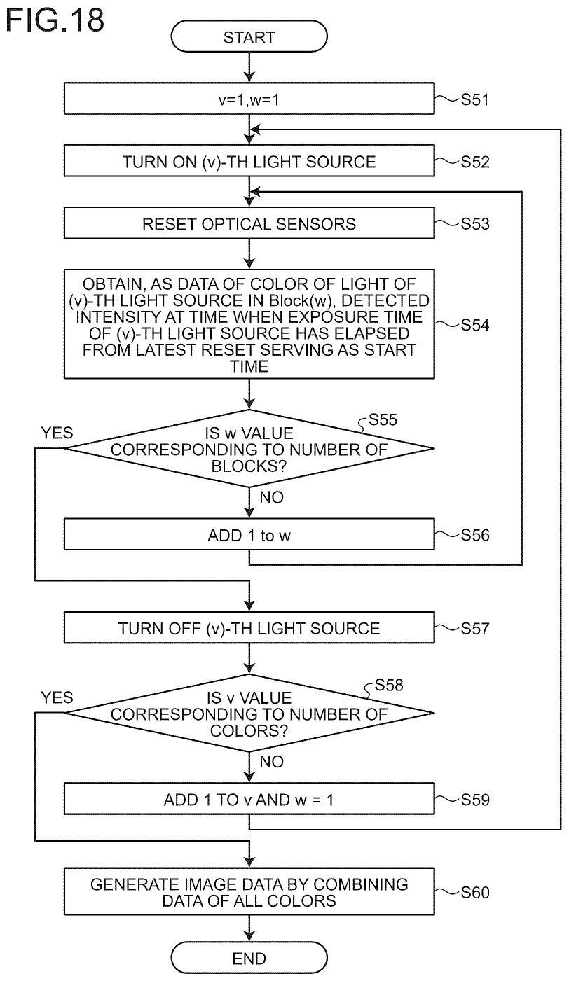

FIG. 18 is a flowchart of the sensor scan in the modification. First, counters for counting values corresponding to the type of the light source and the number of the divided areas (blocks) are set to an initial value of 1 (Step S51). In the example illustrated in FIG. 18, v is set as a variable for counting the type of the light source. w is set as a variable for counting the number of the divided areas (blocks).

After the process at Step S51, the (v)-th light source is turned on (Step S52). The (v)-th light source can be described in the same manner as the description of the (j)-th light source above. After the process at Step S52, the optical sensors WA are reset (Step S53). That is, the reset signal resets the PDs 82 in the same way as the process at Step S23.

After the process at Step S53, a process is performed to obtain, as data of the color of the light of the (k)-th light source in Block(w), the detected intensity at the time when the exposure time of the (k)-th light source in Block(w) has elapsed from the latest reset timing serving as the start timing of the exposure time (Step S54). The latest reset timing as the start timing as of the time of Step S54 refers to timing of the reset performed in the process at Step S53 immediately before Step S54. Block(w) can be described in the same manner as the description of Block(q) above.

The process from Step S53 to Step S54 is performed sensor-row by sensor-row, in the same way as in the description with reference to FIG. 10.

After the process at Step S54, a determination is made as to whether the value of w is a value corresponding to the number of the blocks (Step S55). If the process at Step S55 determines that the value of w is not a value corresponding to the number of the blocks (No at Step S55), one is added to w (Step S56). After the process at Step S56, the process at Step S53 is performed.

As a result, the data of the color of the light from the (v)-th light source in the block Block1 is set by the process from Step S53 to Step S54 performed with w=1. The data of the color of the light from the (v)-th light source in the block Block2 is set by the process from Step S53 to Step S54 performed with w=2. The data of the color of the light from the (v)-th light source in the block Block3 is set by the process from Step S53 to Step S54 performed with w=3. The data of the color of the light from the (v)-th light source in the block Block4 is set by the process from Step S53 to Step S54 performed with w=4.

If the process at Step S55 determines that the value of w is a value corresponding to the number of the blocks (Yes at Step S55), the light source turned on in the process at Step S32 is turned off (Step S57). After the process at Step S57, a determination is made as to whether the value of v is a value corresponding to the number of colors of the light from the light source units 22 (Step S58). The concept of the number of colors of the light herein is the same as that in the process at Step S5 described above.

If the process at Step S58 determines that the value of v is not a value corresponding to the number of colors of the light from the light source units 22 (No at Step S58), one is added to v and the value of w is initialized to be set to one (Step S59). After the process at Step S59, the process at Step S52 is performed.

As a result, the data of the color of the light from the first light source 22R (R data) is obtained by the process from Step S52 to Step S54 performed with v=1. The data of the color of the light from the second light source 22G (G data) is obtained by the process from Step S52 to Step S54 performed with v=2. The data of the color of the light from the third light source 22B (B data) is obtained by the process from Step S52 to Step S54 performed with v=3.

If the process at Step S58 determines that the value of v is a value corresponding to the number of colors of the light from the light source units 22 (Yes at Step S58), the process to generate the image data by combining the plurality of pieces of data of all the colors is performed (Step S60). In the modification, the process at Step S54 is performed for each combination of the color of the light with the block, and in the process at Step S60, all pieces of the data obtained in the process at Step S54 performed multiple times are combined. When the process at Step S60 ends, the processing described with reference to FIG. 18 ends.

The processes in FIGS. 16 and 17 are performed, for example, by the control circuit 30 controlling the operations of the sensor panel 10 and the light source panel 20. The control for the process at Step S54 in FIG. 18 is performed by the detection circuit 15 based on the exposure time (such as the first exposure time TR, the second exposure time TG, or the third exposure time TB) already reflected in the detection circuit 15. Control other than the control for the process at Step S54 in FIG. 18 is performed, for example, by the control circuit 30 controlling the operations of the sensor panel 10 and the light source panel 20.

As described above, according to the modification, the detection device includes the optical sensors (such as the optical sensors WA) arranged in a matrix having a row-column configuration and the partial areas (such as the blocks Block1, Block2, Block3, and Block4), and the exposure time of each of the multiple types of the light sources emitting light in different colors is determined for each of the partial areas, so that finer color calibration can be performed and the detection accuracy of colors can be improved.

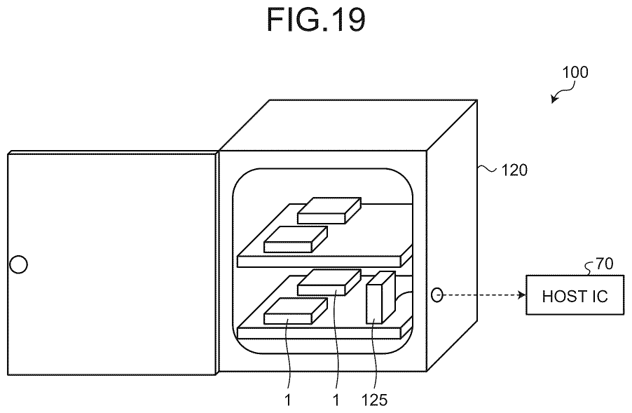

The modification has been described above. The following describes, in more detail, matters applicable to both the embodiment and the modification, with reference to FIGS. 19 to 21.

FIG. 19 is a schematic diagram schematically illustrating a configuration example of a detection system 100 including the detection device 1. As illustrated in FIG. 19, the detection system 100 includes a plurality of the detection devices 1, a host integrated circuit (IC) 70, and a coupling circuit 125. The detection devices 1 are electrically coupled to the common host IC 70 via the coupling circuit 125.

An incubator 120 illustrated in FIG. 19 is maintained such that an environment (temperature, humidity, and the like) therein is suitable for culturing the object to be detected SUB while a door is closed. The detection devices 1 are placed in the incubator 120 and each perform the sensor scan (refer to FIGS. 13 and 18) described above.

FIG. 20 is a schematic diagram illustrating a relation between one of the detection devices 1 and an external configuration. As illustrated in FIG. 20, the detection device 1 is coupled to the coupling circuit 125 by coupling the control circuit 30 to the coupling circuit 125. As illustrated in FIG. 5, the sensor panel 10 faces the light source panel 20. A gap where the object to be detected SUB can be placed is provided between the sensor panel 10 and the light source panel 20.

The object to be detected SUB is made of a light-transmitting material and has the culture medium formed on the upper side thereof. The culture medium is a culture medium in which a colony can be cultured. Hereafter, the term simply called “colony” refers to a colony formed by biological tissues or microorganisms cultured in the culture medium formed on the object to be detected SUB. More specifically, the object to be detected SUB is, for example, a glass Petri dish, but is not limited thereto, and may have another configuration that functions in the same way. The culture medium formed on the object to be detected SUB does not have a totally light-blocking property and has such a degree of light-transmitting property that the degree of light transmission varies depending on the presence or absence of the colony and the thickness of the colony.

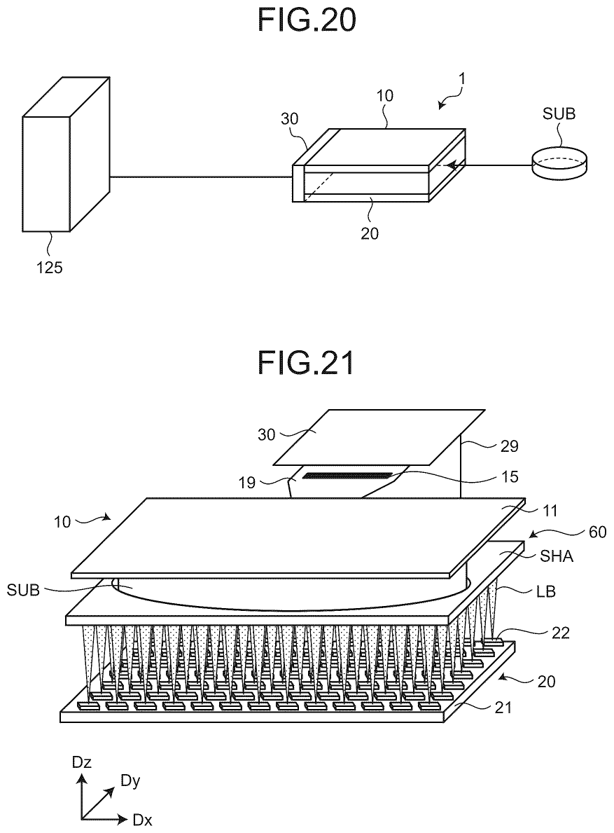

FIG. 21 is a schematic view illustrating a positional relation between the main configuration of the detection device 1 and the object to be detected SUB. When placing the object to be detected SUB between the sensor panel 10 and the light source panel 20, the object to be detected SUB is placed on the placement member 60, as illustrated in FIG. 21. The placement member 60 serves as a member on which the object to be detected SUB can be placed such that the object to be detected SUB is interposed between the detection area SA and the light source panel 20. The placement member 60 has a configuration in which a portion on which the object to be detected SUB is placed is made of a light-transmitting member and a portion located on the outer peripheral side thereof is made of a light-blocking member. To give a specific example, the light-transmitting member is made of glass or a colorless resin, and the light-blocking member is made of a black resin.

The light source unit 22 illustrated in FIG. 5 has a configuration in which the longitudinal directions of the first light source 22R, the second light source 22G, and the third light source 22B are along the second direction Dy, and the first light source 22R, the second light source 22G, and the third light source 22B are arranged in this order from one side toward the other side in the first direction Dx. This configuration is, however, an exemplary form of the light source unit 22, which is not limited to this form. For example, the shape of the first light source 22R, the second light source 22G, and the third light source 22B in the light source unit 22 as viewed from a planar viewpoint and the positional relation among the first light source 22R, the second light source 22G, and the third light source 22B can be changed as appropriate.

The components included in the light source unit 22 are not limited to the first light source 22R, the second light source 22G, and the third light source 22B. For example, the components included in the light source unit 22 may include one or more other light sources that emit light in different colors from those of the first light source 22R, the second light source 22G, and the third light source 22B. The components included in the light source unit 22 may include the other light sources and one or more of the first light source 22R, the second light source 22G, and the third light source 22B.

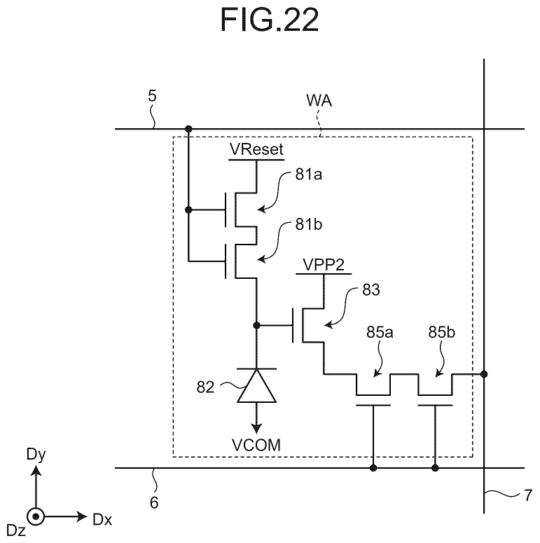

The switching elements 81 and 85 illustrated in FIG. 3 are each not limited to the configuration with a single switching element. FIG. 22 is a circuit diagram illustrating the optical sensor having a partially different configuration from that in FIG. 3. For example, the switching element 81 may have what is called a double-gate configuration with switching elements 81a and 81b, as illustrated in FIG. 22. The switching element 85 may also have what is called a double-gate configuration with switching elements 85a and 85b, as illustrated in FIG. 17.

The object to be detected, such as the object to be detected SUB, is not limited to the Petri dish on which the culture medium is formed, and may have another configuration. The object to be detected may be, for example, a plate for suspension culture.

The arrangement of the optical sensors WA is not limited to the matrix arrangement having a row-column configuration along the first direction Dx and the second direction Dy. For example, the optical sensors WA arranged in the sensor rows adjacent in the second direction Dy need not both be located on a straight line along the second direction Dy. Specifically, the optical sensors WA may be located in what is called a staggered manner. From the viewpoint of sharing the reset signal transmission line 5 and the scan line 6, the arrangement of the optical sensors WA in the first direction Dx is preferably such that the optical sensors WA are located on a straight line along the first direction Dx, but this arrangement is also not essential, and can be changed as appropriate within a range of not hindering the functions of the optical sensors WA and the detection area SA. The arrangement of the light source units 22 in the light source panel 20 is also not limited to the matrix arrangement having a row-column configuration, and can be any arrangement.

The multiplexer 40 is not essential. That is, the signal lines 7 may be coupled to the detection circuit 15 without the multiplexer 40 interposed therebetween. Although, for example, the light limiting member 50 or the placement member 60 is exemplified as the “member on which the object to be detected can be placed so as to interpose the object to be detected (such as the object to be detected SUB) between the detection area SA and the light source units 22”, the placement member is not limited to either of them, and may be a member in other forms.

When either of the members such as the light limiting member 50 and the placement member 60 is provided, the member remains to be provided even while the process to determine the exposure time of each of the light sources, such as each of the first exposure time TR, the second exposure time TG, and the third exposure time TB, is being performed. The process described above with reference to FIGS. 11 and 12 and the process described above with reference to FIGS. 16 and 17 correspond to the process to determine the exposure time of each of the light sources.

Other operational advantages accruing from the aspects described in the present embodiment that are obvious from the description herein, or that are conceivable as appropriate by those skilled in the art will naturally be understood as accruing from the present disclosure.

What is claimed is:

1. A detection device comprising:
a sensor panel that has a detection area in which a plurality of optical sensors are two-dimensionally arranged;
a light source unit comprising multiple types of light sources configured to emit light in colors different from one another;
a member on which an object to be detected is to be placed so as to interpose the object to be detected between the detection area and the light source unit; and
a detection circuit configured to obtain outputs of the optical sensors, wherein
each of the optical sensors comprises a photodiode and is configured to obtain an output corresponding to a photocurrent generated corresponding to light detected by the photodiode,
the light sources configured to emit the light in different colors are configured not to be turned on simultaneously but to be turned on in different periods,
an exposure time when the optical sensor detects the light differs between the light sources that emit light in different colors, and
the output of the optical sensor under conditions where the object to be detected is not placed falls within an output range corresponding to a predetermined target value, regardless of the color of the light emitted by one of the light sources that is turned on.

2. The detection device according to claim 1, wherein the output range is within an output error of 5% with respect to the output of the optical sensor corresponding to the target value.

3. The detection device according to claim 1, wherein the target value is set within 90% to 100% of the range of the output produced by the optical sensor.

4. The detection device according to claim 1, wherein the output of the optical sensor under the conditions where the object to be detected is not placed is an average of the outputs of the optical sensors provided in the detection area.

5. The detection device according to claim 1, wherein
the multiple types of light sources comprise:
a first light source configured to emit light in first color;
a second light source configured to emit light in second color; and
a third light source configured to emit light in third color.

6. The detection device according to claim 1, wherein the exposure times of the multiple types of light sources that emit light in colors different from one another are set in advance.

7. The detection device according to claim 1, comprising a control circuit configured to determine, after energization is started by turning power on, the exposure times of the multiple types of light sources that emit light in colors different from one another.

8. The detection device according to claim 1, wherein
the optical sensors arranged in a matrix having a row-column configuration in the detection area,
the detection area has a plurality of partial areas, and
the exposure times of the multiple types of light sources that emit light in colors different from one another are determined for each of the partial areas.
